(19) United States
(12) Patent Application Publication
(10) Pub. No.: US 2026/0320876 A1
(43) Pub. Date: Oct. 15, 2026

(54) IMAGE GENERATION APPARATUS AND METHOD

(71) Applicant: SAMSUNG ELECTRONICS CO., LTD., Suwon-si (KR)

(72) Inventors: Imkyeong YOU, Suwon-si (KR); Changwon KIM, Suwon-si (KR)

(21) Appl. No.: 19/701,201

(22) Filed: Jun. 8, 2026

Related U.S. Application Data
(63) Continuation of application No. PCT/KR2024/018178, filed on Nov. 18, 2024.

(30) Foreign Application Priority Data
Dec. 8, 2023 (KR) 10-2023-0177398

(51) Int. Cl. G06T 11/60; G06Q 30/018; G06T 1/00

(52) U.S. Cl. CPC G06T 11/60; G06Q 30/018; G06T 1/0021

(57) ABSTRACT

An apparatus and a method for generating a POAP image in a network system to which a plurality of devices are to be connected based on a network may identify user terminals of attending members attending a target event among registered members on the basis of NFTs issued for a specified meeting, and collect event-related data generated by the user terminals. The apparatus may determine a background image corresponding to the target event based on the event-related data, acquire a character image designed to match the background image based on a character owned as an NFT by at least one selected attending member among the attending members and/or the collected event-related data, and superimpose the character image onto the background image to generate the POAP image proving attendance at the event.

### CROSS-REFERENCE TO RELATED APPLICATIONS

This application is a continuation of International Application No. PCT/KR2024/018178 designating the United States, filed on Nov. 18, 2024, in the Korean Ministry of Intellectual Property Receiving Office and claiming priority to Korean Patent Application No. 10-2023-0177398, filed on Dec. 8, 2023, in the Korean Ministry of Intellectual Property, the disclosures of each of which are incorporated by reference herein in their entireties.

### BACKGROUND

### Field

The disclosure relates to a device and a method for generating an image based on a network.

### Description of Related Art

Electronic devices, such as smart phones, mobile phones, and tablet devices, may be representative examples of electronic devices that are easily carried by users. Application programs for providing various functions may be installed on the electronic device. The electronic device may execute an installed application program in response to the user's manipulation. The electronic device may display information according to the execution of an application program through a display.

The electronic device may provide various functions based on interworking with the network environment, and gradually comes in wide use. For example, the electronic device is used in a wide range of areas of life, such as taking photographs, watching content, or authenticating one's identity.

Humans may belong to a group such as friends, a club, a company, or a religious organization and act as a member thereof. Members belonging to the group may primarily have a common interest, value, or vision. One of the functions provided based on a network environment as such a change of the times may be a social network service (SNS). The SNS may refer to an online service that establishes a relationship network among people who share an interest or activity of an individual.

As the online service provided based on the relationship network enables sharing of information or communication based on experiences of individuals belonging thereto, accuracy of related data needs to be ensured.

### SUMMARY

Embodiments of the disclosure may provide a device and a method for generating a proof of attendance protocol (hereinafter referred to as ‘POAP’) image in a network system in which a plurality of devices are connected based on a network.

According to an example embodiment, a method for generating a proof of attendance (POAP) image at a server may include: identifying user terminals of attending members who attended a target event from among enrolled members based on a non-fungible token (NFT) issued for a specified gathering, collecting event-related data generated by the user terminals, determining a background image corresponding to the target event based on the event-related data, obtaining a character image configured to match the background image based on a character owned as an NFT by at least one selected attending member among the attending members and/or the collected event-related data, and generating the POAP image certifying attendance at the event by synthesizing the character image on the background image.

According to an example embodiment, a server may include: a transceiver, at least one memory, and at least one processor, comprising processing circuitry, operatively connected to the transceiver and/or the at least one memory, the memory may store instructions that, when executed by at least one processor, individually or in any combination, cause the server to: identify user terminals of attending members who attended a target event from among enrolled members based on a non-fungible token (NFT) issued for a specified gathering, control the transceiver to collect event-related data generated by the user terminals, determine a background image corresponding to the target event based on the event-related data, obtain a character image configured to match the background image based on a character owned as an NFT by at least one selected attending member among the attending members and/or the collected event-related data, and generate a proof of attendance protocol (POAP) image certifying attendance at the event by synthesizing the character image on the background image.

According to an example embodiment of the disclosure, by automatically generating a POAP image capable of certifying attendance at a gathering or an event by applying NFT technology in a system based on a network environment, trust between members may be enhanced.

Effects of the present disclosure are not limited to the foregoing, and other unmentioned effects would be apparent to one of ordinary skill in the art from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration for generating a POAP image in a network environment according to various example embodiments.

FIG. 2 is a signal flow diagrams illustrating example operations for generating a POAP image in a network environment according to various example embodiments.

FIGS. 3A and 3B are flowcharts illustrating example operations for issuing a POAP image at a user terminal according to various example embodiments.

FIG. 4 is a flowchart illustrating example operations for issuing a POAP image at a server according to various example embodiments.

FIG. 5 is a block diagram illustrating an example configuration of a user terminal according to various example embodiments.

FIG. 6 is a block diagram illustrating an example configuration of a server according to various example embodiments.

FIG. 7A is a diagram illustrating a pop-up example of a scan notification message at a user terminal according to various example embodiments.

FIG. 7B is a diagram illustrating an example of managing an event schedule at a user terminal according to various example embodiments.

FIG. 8 is a diagram illustrating an example of selecting a representative image for POAP generation to certify attendance at a target event at a user terminal according to various example embodiments.

FIGS. 9A and 9B are diagrams illustrating examples of generating a background image for POAP generation at a server according to various example embodiments.

FIGS. 10A and 10B are diagrams illustrating examples of determining a watermark to certify attendance at a target event in case of generating a POAP image at a server according to various example embodiments.

FIGS. 11A and 11B are diagrams illustrating examples of determining a watermark to certify attendance at a target event in case of generating a POAP image at a server according to various example embodiments.

FIGS. 12A and 12B are diagrams illustrating examples of determining a watermark to certify attendance at a target event in case of generating a POAP image at a server according to various example embodiments.

FIG. 13 is a diagram illustrating an example of determining a watermark to certify participation in a target event in case of generating a POAP image at a server according to various example embodiments.

FIG. 14 is a diagram illustrating an example of determining a watermark to certify participation in a target event in case of generating a POAP image at a server according to various example embodiments.

FIGS. 15A, 15B 15C and 15D are diagrams illustrating examples of generating a POAP image at a server according to various example embodiments.

FIGS. 16A, 16B, 16C, 16D and 16E are diagrams illustrating examples of generating a POAP image using a watermark symbolizing a category of a representative image at a server according to various example embodiments.

FIGS. 17A, 17B, 17C, 17D and 17E are diagrams illustrating examples of generating a POAP image using a composite watermark at a server according to various example embodiments.

FIG. 18 is a diagram illustrating an example of generating a POAP image using a plurality of representative images at a server according to various example embodiments.

FIG. 19 is a diagram illustrating an example of generating a POAP image by reflecting a result of a target event at a server according to various example embodiments.

In connection to the description of the drawings, the same or similar reference numerals may be used for the same or similar components.

### DETAILED DESCRIPTION

Hereinafter, various example embodiments of the disclosure are described in greater detail with reference to the drawings. However, the disclosure may be implemented in other various forms and is not limited to the various embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

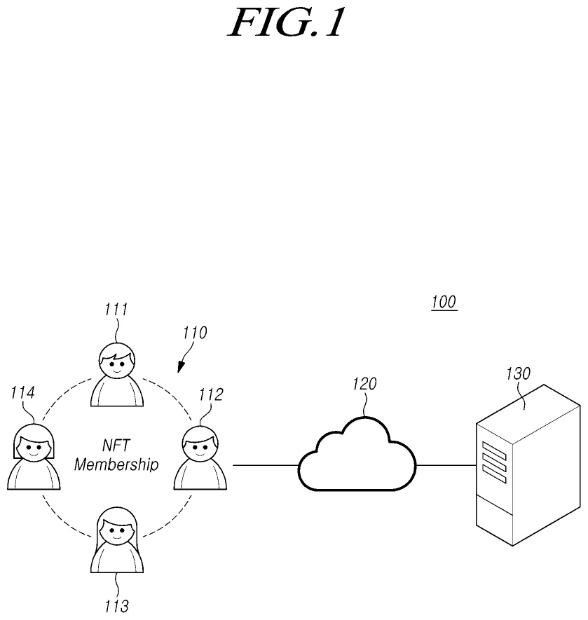

FIG. 1 is a diagram illustrating an example configuration for generating a POAP image in a network environment 100 according to various example embodiments.

Referring to FIG. 1, the network environment 100 may be a system in which a plurality of nodes are connected via a transmission medium to exchange data. The network environment 100 may provide a platform in which the user terminals 111, 112, 113, 114 and the server 130 may communicate using the network 120 as a transmission medium. The transmission medium may be based on short-range communication or long-range communication. The transmission medium based on the short-range communication may use a communication protocol such as Bluetooth, wireless fidelity (Wi-Fi) direct, or infrared data association (IrDA) as a standard. The transmission medium based on the long-range communication may use a communication protocol such as legacy cellular, 5G, next-generation communication, the Internet, or a computer network (e.g., LAN or WAN) as a standard.

The plurality of nodes may include hosts capable of executing an application program (or an app) corresponding to a specific event. The hosts may include user terminals 111, 112, 113, 114 (or an attendee group) or a server 130 for generating a POAP image for a target event. In the following description, for convenience, ‘user terminal 110’ may be used to indicate a specific user terminal included in the attendee group. The POAP may be a protocol capable of changing the way people think about collectibles or souvenirs. The POAP provides scarcity, immutability, accessibility, or diversity, and thus has value as an investment product, but also has potential risks.

The user terminals 111, 112, 113, 114 may be attendee terminals that attended the target event. The user terminals 111, 112, 113, 114 may include a portable communication device (e.g., a smartphone, a mobile phone, or a tablet device), a computer device, a portable multimedia device, a portable medical device, a camera, a wearable device, a home appliance device, etc. A user terminal according to various embodiments of the disclosure is not limited to the above-described devices. The user terminals 111, 112, 113, 114 may have an application program installed thereon for providing various functions. The user terminals 111, 112, 113, 114 may execute the installed application program in response to a user's manipulation. The user terminals 111, 112, 113, 114 may display information according to the execution of the application program through a display.

According to an example, the user terminals 111, 112, 113, 114 may be attendee terminals possessed by attending members who attended a target event. The target event may be an event held by a predetermined (e.g., specified) gathering. The target event may be an event for which a POAP image is to be generated. The predetermined gathering may be, e.g., a gathering of enrolled members who share at least one purpose such as travel, restaurant visiting, exercise, travel, movie watching, or reading, or who participate together. The enrolled members may hold a non-fungible token (NFT) issued for the predetermined gathering. In an example, the NFT may be used to identify attending members who attended the target event from among the enrolled members. The NFT may be issued only to an enrolled member who wishes or has applied to attend the target event from among the enrolled members. The NFT may be issued only to an attending member who attended the target event from among the enrolled members. The NFT may be stored in the user terminals 111, 112, 113, 114.

In an example, a POAP NFT may be a unique digital asset stored on a blockchain. The POAP NFT may be an NFT badge issued only to a person who attended an actual event. The POAP NFT may be used for the purpose of commemorating an event, a conference, an occasion, or a gathering. For example, a host of the corresponding event may issue a POAP NFT to commemorate attendance at the occasion through a POAP platform. The attendees of the corresponding event may collect the POAP NFT issued by the host by attending the occasion. The POAP NFT may have high scarcity and value because it is often created in a limited quantity. The POAP NFT serves as a record of attending various blockchain occasions for collectors, and thus may also be used in the form of a resume in the blockchain industry. In an example, the POAP NFT may be issued as a POAP image. In various embodiments, a method for generating a POAP image based on data collected from the user terminals 111, 112, 113, 114 of attending members who attended the target event is prepared for issuing a POAP NFT corresponding to the target event.

The network 120 may include a plurality of nodes forming mutual communication links based on at least one communication protocol. The plurality of nodes may deliver data received from a preceding node to a following node. The plurality of nodes may be hosts that perform only a relay function, rather than hosts that consume data.

The user terminal 111, 112, 113, 114 may perform a scan operation to discover an attendee terminal from among adjacent terminals if a scan function is activated. The scan operation may be performed based on a short-range communication protocol such as Bluetooth. The user terminal 111, 112, 113, 114 may transmit scan information to the server. The scan information may include information about an attendee terminal recognized as being nearby by performing the scan operation. The information about the attendee terminal may include at least one of identification information of the corresponding attendee terminal or identification information of the corresponding attending member. The scan information may include information about the target event such as target event identification information.

The user terminal 111, 112, 113, 114 may configure event-related data according to an activity of an attending member in the target event and transmit the event-related data to the server 130. The event-related data may be defined for each activity category in the target event. The activity category may be classified into, e.g., photo taking, content (e.g., movie or book) reservation or viewing, or the like.

The user terminal 111, 112, 113, 114 may receive a POAP image from the server 130. The user terminal 111, 112, 113, 114 may store and/or output the POAP image through a screen.

The server 130 may identify the user terminals 111, 112, 113, 114 of attending members who attended the target event from among enrolled members based on an NFT issued for a predetermined gathering. The server 130 may receive scan information from the user terminals 111, 112, 113, 114. The server 130 may identify attending members who attended the target event based on the scan information.

The server 130 may determine a host for the target event from among the attending members. The server 130 may receive event-related data generated by the user terminals 111, 112, 113, 114. The event-related data may include at least one of a video captured by the user terminals 111, 112, 113, 114, metadata of the captured video, ambient sound recorded at a time of video capture, schedule information, or a usage record of an application program.

The server 130 may determine a background image corresponding to the target event based on the event-related data. In an example, the server 130 may analyze the event-related data to extract core data related to the target event. The server 130 may transmit the core data to the host terminal (e.g., user terminal 111). The server 130 may include at least one candidate image to be recommended as the background image in the core data. The server 130 may receive a category identifier corresponding to the core data from the host terminal 111. The category identifier may include identification information indicating use as the background image from among the at least one candidate image.

The server 130 may obtain detailed context information for the core data based on the category identifier. The server 130 may determine a background image corresponding to the target event based on the event-related data and/or the detailed context information. The server 130 may delete an attending member image included in the background image.

The server 130 may obtain a character image designed to match the background image as a watermark based on a character owned as an NFT by at least one selected attending member among the attending members and/or the collected event-related data. The at least one selected attending member may be determined from, e.g., at least one attending member included in the background image. The at least one selected attending member may be determined by considering similarity to the background image from among the attending members based on, e.g., the event-related data. The server 130 may determine attire, a pose, or a facial expression of at least one character based on the detailed context information, and obtain the character image by reflecting the determined attire, pose, or facial expression. The server 130 may obtain a watermark based on an emblem, a logo, and/or text corresponding to the target event or the predetermined gathering that hosted the target event.

The server 130 may generate a POAP image certifying attendance at the event by synthesizing the watermark on the background image. The server 130 may transmit the POAP image to the user terminals 111, 112, 113, 114. The server 130 may transmit the POAP image to the host terminal 111.

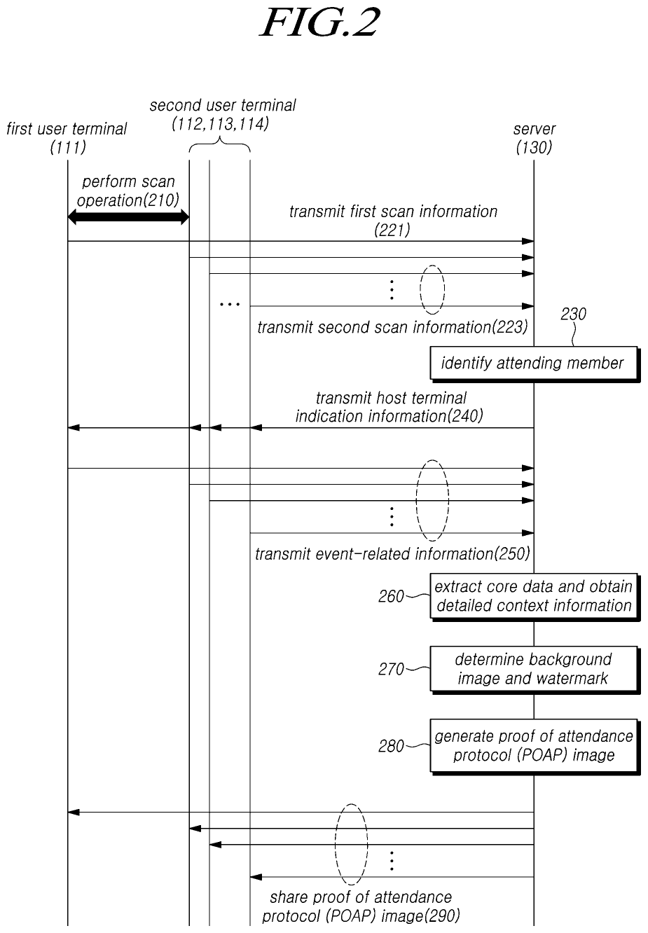

FIG. 2 is a signal flow diagram illustrating example operations for generating a POAP image in a network environment (network environment 100 of FIG. 1) according to various example embodiments. The network environment 100 may provide data transmission between hosts for generating a POAP image for certifying attendance at a target event based on a predetermined transmission medium. The hosts may include a plurality of user terminals (e.g., user terminals 111, 112, 113, 114 of FIG. 1) or at least one server (e.g., server 130 of FIG. 1). The user terminals 111, 112, 113, 114 may be electronic devices of members who attended the target event (hereinafter referred to as “attending members”). At least one user terminal (e.g., first user terminal 111 of FIG. 1) among the user terminals 111, 112, 113, 114 may serve as a client for requesting generation of a POAP image. The user terminal to serve as the client may be a designated representative terminal, client terminal, or host terminal (hereinafter collectively referred to as “host terminal”) from among the user terminals 111, 112, 113, 114. The server 130 may collect data related to the target event (hereinafter referred to as “event-related data”) from the user terminals 111, 112, 113, 114. The server 130 may generate a POAP image for certifying attendance at the target event using the collected event-related data.

Referring to FIG. 2, user terminals (e.g., a first user terminal 111 or second user terminals 112, 113, 114) may perform a scan operation (operation 210). The scan operation may be an operation of discovering an adjacent terminal located nearby. The adjacent terminal located nearby may be regarded as a terminal of an attending member for attending the target event (hereinafter referred to as “attendee terminal”). The user terminals 111, 112, 113, 114 may activate a recognition setting that allows the scan operation. The user terminals 111, 112, 113, 114 may perform the scan operation on adjacent terminals with the recognition setting activated from among peripheral user terminals located within a predetermined distance. The scan operation may be performed based on a short-range communication protocol such as Bluetooth. In an example, the user terminals 111, 112, 113, 114 may share identification information with each other with an adjacent terminal existing nearby and identify whether it is an attendee terminal that attended the target event based on the identification information. The identification information may be an NFT issued for the purpose of attending the target event. The NFT may be a POAP token.

The user terminals 111, 112, 113, 114 may transmit scan information to the server 130 (operation 221 and/or operation 223). For example, the first user terminal 111 may transmit first scan information to the server 130, and the second user terminals 112, 113, 114 may transmit second scan information to the server 130. The scan information may include information about an attendee terminal recognized as being nearby by performing the scan operation. The information about the attendee terminal may include at least one of identification information of the corresponding attendee terminal or identification information of the corresponding attending member. The scan information may include information about the target event such as target event identification information. The user terminals 111, 112, 113, 114 may transmit scan information to the server 130 each time an attendee terminal is identified by the scan operation. The user terminals 111, 112, 113, 114 may collectively transmit scan information about all attendee terminals identified by the scan operation to the server 130 at a time when the target event starts.

The server 130 may identify attending members based on the scan information transmitted by the user terminals 111, 112, 113, 114 (operation 230). The identification of the attending members may be performed by recognizing a user terminal that attended the target event. The server 130 may determine a host from among the identified attending members. The determination of the host may be determining the user terminal of the corresponding attending member as the host terminal. The server 130 may determine, e.g., a user terminal that first transmitted scan information as the host terminal. The server 130 may determine, e.g., a user terminal of an attending member who first registered the target event in their schedule as the host terminal. The server 130 may determine, e.g., a user terminal designated by the user terminals 111, 112, 113, 114 as the host terminal.

The server 130 may transmit information about the determined host terminal to the user terminals 111, 112, 113, 114 (operation 240). The information about the determined host terminal may include host terminal indication information indicating the user terminal determined as the host terminal. The server 130 may transmit the information about the determined host terminal only to the host terminal (e.g., the first user terminal 111). In this case, the host terminal 111 may propagate to the remaining user terminals (e.g., the second user terminals 112, 113, 114) that it has been determined as the host terminal.

The start of the target event may be triggered by any one user terminal (e.g., the host terminal 111) included in the user terminals 111, 112, 113, 114. The time when the target event starts may also be triggered by the server 130. If the host terminal 111 is designated before the scan operation is performed, the host terminal 111 may perform the scan operation to determine the start and/or end of the target event. The host terminal 111 may determine the start of the target event in response to, e.g., the user terminals of all attending members being identified, or at least a minimum number of user terminals being identified at a scheduled time. The host terminal 111 may also determine the end of the target event in response to, e.g., an attending member who had attended the target event no longer being identified nearby while the target event is in progress, or the number of identified attending members being less than a predetermined number.

In case that the target event starts, the user terminals 111, 112, 113, 114 may transmit event-related data to the server 130 (operation 250). The user terminals 111, 112, 113, 114 may continue to transmit event-related data to the server 130 until the end of the target event is determined. The server 130 may collect the event-related data transmitted by the user terminals 111, 112, 113, 114. The server 130 may collect the event-related data from the user terminals 111, 112, 113, 114 until the target event ends.

The event-related data may be defined for each activity category in the target event. The activity category may be classified into, e.g., photo taking, content (e.g., movie or book) reservation or viewing, or the like.

If the activity category is photo taking, the event-related data may be classified based on an activity monitoring application program. The activity monitoring application program may be classified into, e.g., a camera app, a gallery app, or a message app.

If the activity monitoring application program is a camera app, the event-related data may include image data (e.g., photo and/or video data or metadata of the corresponding image) captured at the target event. The metadata of the image may include data about capture time and/or location. The event-related data may include audio data of recorded ambient sound for a predetermined time (e.g., 10 seconds) before, after, or before/after the time when the corresponding image was captured. The audio data may include a sound file in which speech and/or exclamations sensed during the predetermined time are recorded. In this case, the server 130 may obtain the captured image and/or metadata from the event-related data as data to be collected, or obtain ambient sound data recorded for the predetermined time as data to be collected.

If the activity monitoring application program is a gallery app, the event-related data may include image data (e.g., photo and/or video data or metadata of the corresponding image) captured at the target event and recorded in the gallery, or transmitted externally using an application program (e.g., a message app or an SNS app) providing a sharing function from the gallery app. In this case, the server 130 may obtain the number of times and/or time that the image data was transmitted externally.

If the activity monitoring application program is a message app, the event-related data may include image data (e.g., photo and/or video data or metadata of the corresponding image) captured and transmitted in the message app. In this case, the server 130 may obtain the number of times and/or time that the image data was transmitted externally. If the activity monitoring application program is a message app, the event-related data may obtain the number of times and/or time that a notification (e.g., like) received in response to the transmitted image data was received.

If the activity category is content reservation or viewing, or reading, the event-related data may be classified based on an activity monitoring application program. The activity monitoring application program may be classified into, e.g., a movie reservation app or a book reading app.

If the activity monitoring application program is a movie reservation app, the event-related data may include data related to an activity of reserving a movie, registering a schedule in a calendar app, and/or uploading to SNS with a hashtag of the movie title during an event schedule. In this case, the server 130 may obtain information about the reserved or viewed movie title and/or viewing schedule from the event-related data as data to be collected.

If the activity monitoring application program is a book reading app, the event-related data may include data related to an activity of using the book reading app, copying or screen capturing a phrase included in the book, or uploading to SNS during an event schedule. In this case, the server 130 may obtain information about the book title or reading schedule from the event-related data as data to be collected.

Table 1 below illustrates an example of data to be collected obtained based on an activity of an attending member at the target event.

TABLE 1

| | Monitoring | Detailed Usage | |
|---|---|---|---|
| Activity Category | App | Activity | Data to Be Collected |
| Photo Taking | Camera App | Photo Taking | Captured photo and capture- |
| | | | related metadata |
| | | | (time/location) |
| | | | Recorded sound file of |
| | | | ambient sound including |
| | | | speech or exclamations |
| | Gallery App | Image Upload | Upload count/time |
| | Message App | Image Transmission | Transmission count/time |
| | | Notification | Notification reception |
| | | Reception | count/time |
| Content | Movie | Movie reservation | Movie title/viewing |
| Reservation/Viewing | Reservation | during event | schedule |
| | App | schedule | |
| | | Schedule registration | |
| | | SNS upload | |
| | Book Reading | Using book reading | Book title/reading schedule |
| | App | app during event | |
| | | schedule | |
| | | Phrase copying | |
| | | and/or capture | |
| | | SNS upload | |

In case of detecting the end of the target event, the server 130 may extract core data based on the event-related data collected from the user terminals 111, 112, 113, 114 and obtain detailed context information for the extracted core data (operation 260).

The event-related data may be defined for each activity category in the target event. The activity category may be classified into, e.g., photo taking, content reservation or viewing, or reading.

If the activity category is photo taking, the server 130 may analyze data from the event-related data such as the number of captures of the same subject, the number of times a captured image was transmitted through a message app or an SNS app, or the number of times a notification (e.g., like) was received in response to an image transmitted through a message app.

The server 130 may classify collected images based on the same time and/or location, or extract images captured with the same subject (e.g., object, food, or background) as a subject and obtain the number of captures, based on the analyzed data. The server 130 may obtain the total number of times a specific image was transmitted or the total number of times a notification was received in response to the transmitted specific image based on the analyzed data.

Upon obtaining the result according to the analysis, the server 130 may calculate the total sum of count numbers per image, and determine or obtain the image with the highest calculated total sum as a representative image representing the target event.

If the activity category is content reservation or viewing, or reading, the server 130 may analyze the movie title and/or viewing schedule, or the book title and/or reading schedule from the event-related data.

The server 130 may determine or obtain the movie title as core data representing the target event if the movie title and/or viewing schedule are analyzed based on the analyzed data. The server 130 may determine or obtain the book title as core data representing the target event if the book title and/or reading schedule are analyzed based on the analyzed data.

Table 2 below illustrates an example of deriving core data by analyzing event-related data.

TABLE 2

| | | | Core Data |
|---|---|---|---|
| | | | Derivation |
| Activity Category | Data Analysis | Analysis Method | Method |
| Photo Taking | Number of | Classify captured images based | Sum count |
| | captures of the | on the same time/location | numbers per |
| | same subject | Extract images including the | collected image |
| | | same subject (e.g., | Derive the |
| | | object/food/background) and | image with the |
| | | review the number of captures | highest sum |
| | Number of | Sum transmission records of | score as core |
| | transmissions | specific photo | data |
| | through message | | |
| | or SNS | | |
| | Number of | Sum notification reception | |
| | notification | records | |
| | receptions | | |
| Content | Movie | Use collected movie | Derive movie |
| Reservation/Viewing | title/viewing | title/viewing schedule | title with |
| | schedule | | detected |
| | | | viewing |
| | | | schedule as |
| | | | core data |
| | Book | Use collected book title/reading | Derive book |
| | title/reading | schedule | title with |
| | schedule | | detected |
| | | | reading |
| | | | schedule as |
| | | | core data |

The server 130 may transmit the core data to the first user terminal 111 being the host terminal. The first user terminal 111 may output a representative image included in the core data through a screen. The first user terminal 111 may output a guide message identifying that a POAP image is produced with the core data through the screen. The guide message may be, e.g., ‘We recommend a photo that best represents the event. Would you like to produce a POAP image with this photo?’ The first user terminal 111 may display an identifier (e.g., emoticon or icon) for selecting a response to the guide message on the screen. The identifier may include “Change Image” and “Confirm.” In case that “Change Image” is selected by the user, the first user terminal 111 may display candidate images prepared for producing a POAP image on the screen. The candidate image may be selected from among images captured at the same location, time zone, and/or subject as the image recommended by the server 130. The core data may include candidate images and analysis data for the candidate images. In this case, the first user terminal 111 may select the candidate image considering the order of higher sum scores obtained by analysis.

In case that one image is selected from among the candidate images by the user, the first user terminal 111 may display the selected candidate image enlarged on the screen. In case that the user selects the candidate image displayed enlarged, the first user terminal 111 may determine to use the selected candidate image as the representative image. The first user terminal 111 may display an identifier (e.g., emoticon or icon) on the screen so that the user may select whether to select the candidate image displayed enlarged as the representative image. The identifier may include “Cancel” and “Confirm.”

In case that “Confirm” is selected by the user, the first user terminal 111 may display a predetermined guide message and identifiers for selecting a category of the selected representative image on the screen. The identifiers that may be displayed on the screen for selecting the category may include “Travel,” “Restaurant,” and “Exercise.” The first user terminal 111 may display an identifier for the user to select whether to transmit information about the selected category to the server 130 on the screen. The identifier may include “Cancel” and “Confirm.” In case that the user selects “Confirm,” the first user terminal 111 may transmit the image selected as the representative image and/or information about the selected category to the server 130.

The server 130 may obtain detailed context information for the core data selected by itself through analysis or the core data provided by the first user terminal 111. In an example, the server 130 may finalize the activity category based on the finally determined core data. The activity category may be classified into, e.g., photo taking, content reservation or viewing, or reading. In case that the activity category is finalized, the server 130 may finalize a core data category. In case that the activity category is “photo taking,” the core data category may include “travel,” “restaurant,” or “exercise.” In case that the activity category is “content reservation or viewing, or reading,” the core data category may include “movie reservation app” or “book reading app.”

The server 130 may derive detailed context information for each core data category.

Table 3 below illustrates an example of context information that may be derived for each core data category.

TABLE 3

| | Core Data | |
|---|---|---|
| Activity Category | Category | Detailed Context Information Derivation |
| Photo Taking | Travel | Mood keyword derivation |
| | Restaurant | In case of photos with members captured |
| | | together, analyze facial expressions/gestures of |
| | | members |
| | | Analyze message written or hashtag in case of |
| | | uploading photo through message or SNS |
| | | Convert speech and/or exclamations |
| | | included in sound file recorded at time of capture |
| | | to text, and analyze content |
| | Exercise | Mood keyword derivation |
| | | In case of photos with members captured |
| | | together, analyze facial expressions/gestures of |
| | | members |
| | | Analyze message written or hashtag in case of |
| | | uploading photo through message or SNS |
| | | Convert speech and/or exclamations included in |
| | | sound file recorded at time of capture to text, and |
| | | analyze content |
| | | Retrieve exercise record data recorded by |
| | | detecting exercise circumstance through |
| | | movement, and obtain exercise record data |
| | | performed before/after capture time |
| | | Exercise type, distance, and time record |
| Content | Movie/Reservation | Obtain main poster image and/or movie title logo |
| Reservation/Viewing | Book Reading | Obtain book cover image and/or book title logo |

The server 130 may obtain an image source for POAP production based on the detailed context information. The image source may refer, for example, to data for obtaining a background image from the representative image or generating a watermark.

The server 130 may generate the background image by editing the representative image selected from among images in which an attending member is captured (operation 270). In an example, in case that an attending member is captured in the representative image, the server 130 may generate the background image by deleting an image of the attending member from the representative image using image editing technology based on AI technology, and editing the image so that a feature part capable of recognizing the target event is included.

The server 130 may generate the background image by editing the representative image selected from among images in which an attending member is not captured (operation 270). In an example, in case that an attending member is not captured in the representative image, the server 130 may generate the background image by editing the representative image using image editing technology based on AI technology so that a feature part capable of recognizing the target event is included.

The server 130 may generate the background image by editing a poster of a viewed movie (operation 270). The server 130 may generate the background image by editing an image capturing a main scene from a viewed movie. The server 130 may generate the background image by editing a cover image of a read book. The server 130 may generate the background image by editing an image of a music album cover.

The server 130 may extract a watermark to certify attendance at the target event so that a POAP image to be produced using the representative image may certify attendance at the target event (operation 270). For example, the server 130 may determine a watermark using a character image owned as an NFT by at least one attending member captured in the representative image. The character image may be produced by reflecting attire, a pose, or a facial expression of an attending member included in the image. The facial expression and/or pose of the character image may be produced by reflecting mood keyword information derived as detailed context information.

In case that there is no attending member captured in the representative image, the server 130 may determine a watermark using a character image obtained by reflecting mood keyword information derived as detailed context information (operation 270). For example, the character image may be produced by reflecting a suitable pose and/or facial expression based on the mood keyword information.

In case that the image used as the representative image is a movie poster or a capture image, the server 130 may determine one of the character images of attending members as a watermark by considering similarity with a person or character included in the movie poster or the capture image (operation 270). The character image determined as the watermark may be selected from among character images owned as an NFT by attending members considering a facial expression, a posture, or attire of a person or character included in the movie poster or the capture image.

In case that the image used as the representative image is a movie poster or a capture image, the server 130 may determine a character image easy to synthesize with a person or character included in the movie poster or the capture image as a watermark from among character images owned as an NFT by attending members (operation 270).

The server 130 may determine a character image matching a facial expression or gesture predictable from content selected or captured from a book by an attending member, or text or a hashtag added in case of uploading to SNS as the watermark from among character images owned as an NFT by attending members (operation 270).

In case that a logo for the target event is present, the server 130 may extract the corresponding logo as an image, edit a background area of the extracted logo image to be transparent, and obtain only the logo part as a watermark (operation 270).

The server 130 may collect information about the target event and extract text or a logo corresponding to a location, time, exercise record, content name, or an occasion title hosted by an organization based on the collected information. The server 130 may obtain a watermark using the extracted record text or logo (operation 270).

The server 130 may generate a POAP image based on image synthesis of placing at least one watermark on the background image (operation 280). In an example, the server 130 may synthesize a character image as a watermark on the background image considering a position of an attending member in the representative image. In an example, the server 130 may synthesize the character image as a watermark on the background image considering a pose or a facial expression of the character image. In an example, the server 130 may synthesize a logo image as a watermark on the background image. In an example, the server 130 may synthesize record text as a watermark on the background image. In an example, the server 130 may synthesize a character image and a logo image as a watermark on the background image. In an example, the server 130 may synthesize a character image and an emblem image as a watermark on the background image. In an example, the server 130 may synthesize a character image and record text as a watermark on the background image. In an example, the server 130 may synthesize a character image, a logo image, and an emblem image as a watermark on the background image. In an example, the server 130 may synthesize a character image, a logo image, and record text as a watermark on the background image. In an example, the server 130 may synthesize a character image, an emblem image, and record text as a watermark on the background image. In an example, the server 130 may synthesize a logo image and an emblem image as a watermark on the background image. In an example, the server 130 may synthesize a logo image, an emblem image, and record text as a watermark on the background image.

For sharing of the POAP image, the server 130 may transmit the POAP image to the user terminals 111, 112, 113, 114 or the host terminal 111 (operation 290).

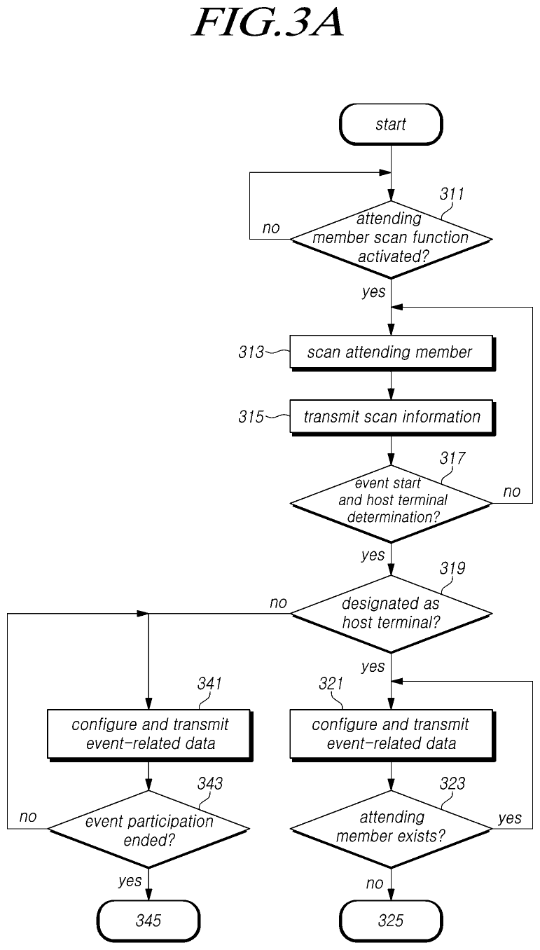

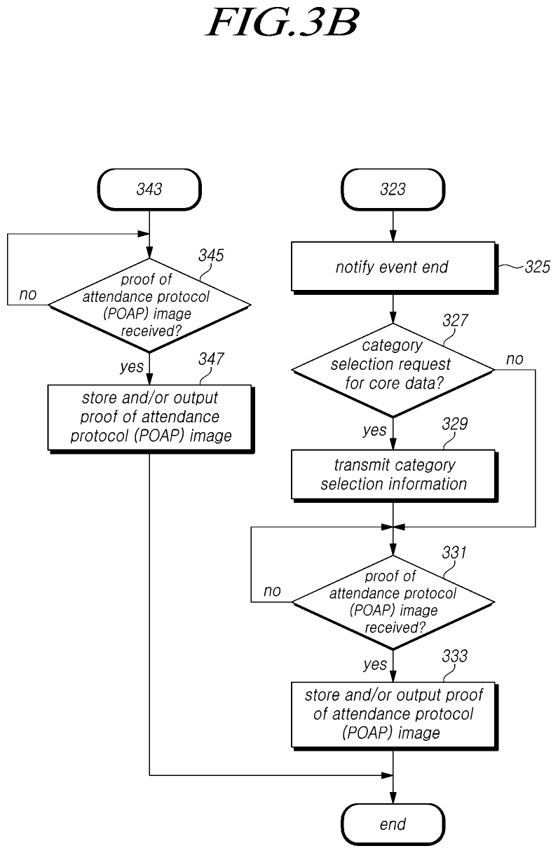

FIGS. 3A and 3B are flowcharts illustrating example operations for issuing a POAP image at a user terminal (e.g., user terminals 111, 112, 113, 114 of FIG. 1) according to various example embodiments. Hereinafter, the description is based on the assumption that the operations are performed by one user terminal 111 among the user terminals 111, 112, 113, 114, but the remaining user terminals may also be capable of performing the same operation.

Referring to FIGS. 3A and 3B, the user terminal 111 may determine whether an attending member scan function is activated in operation 311. The attending member scan function may be a function prepared for performing an operation of scanning whether a user terminal of an attending member who attended the target event is located nearby.

If the attending member scan function is activated, the user terminal 111 may perform an attending member scan to discover an attendee terminal from among adjacent terminals located nearby in operation 313. In an example, the user terminal 111 may perform a scan operation on adjacent terminals with a recognition setting activated from among peripheral user terminals located within a predetermined distance. The scan operation may be performed based on a short-range communication protocol such as Bluetooth. The user terminal 111 may share identification information with each other with an adjacent terminal existing nearby and identify whether it is an attendee terminal that attended the target event based on the identification information. The identification information may be an NFT issued for the purpose of attending the target event. The NFT may be a POAP token.

The user terminal 111 may transmit scan information to a server (e.g., server 130 of FIG. 1) in operation 315. The scan information may include information about an attendee terminal recognized as being nearby by performing the scan operation. The information about the attendee terminal may include at least one of identification information of the corresponding attendee terminal or identification information of the corresponding attending member. The scan information may include information about the target event such as target event identification information. The user terminal 111 may transmit scan information to the server 130 each time an attendee terminal is identified by the scan operation. The user terminal 111 may collectively transmit scan information about all attendee terminals identified by the scan operation to the server 130 at a time when the target event starts.

The user terminal 111 may determine whether the start of the target event and the host terminal are determined in operation 317. The start of the target event may be triggered by the user terminal 111. The time when the target event starts may also be triggered by the server 130. If the host terminal 111 is designated before the scan operation is performed, the host terminal 111 may perform the scan operation to determine the start of the target event. The host terminal 111 may determine the start of the target event in response to, e.g., the user terminals of all attending members being identified, or at least a minimum number of user terminals being identified at a scheduled time.

The user terminal 111 may determine whether it has been designated as the host terminal in operation 319. In case of being designated as the host terminal, the user terminal 111 may perform an operation as the host terminal. In case of being not designated as the host terminal, the user terminal 111 may perform an operation as an attendee terminal.

In case of being designated as the host terminal, the user terminal 111 may configure event-related data according to an activity of an attending member in the target event and transmit the event-related data to the server 130 in operation 321. The event-related data may be defined for each activity category in the target event. The activity category may be classified into, e.g., photo taking, content (e.g., movie or book) reservation or viewing, or the like. The event-related data may be as defined by Table 1 above. The user terminal 111 may continue to transmit event-related data to the server 130 until the end of the target event is determined.

The user terminal 111 may determine whether an attending member is present in operation 323. For this purpose, the user terminal 111 may perform the scan operation periodically or aperiodically. The user terminal 111 may determine the end of the target event based on, e.g., an attendee terminal that had attended the target event no longer being identified nearby while the target event is in progress, or the number of identified attendee terminals being less than a predetermined threshold level.

In case that the end requirement of the target event is satisfied, the user terminal 111 may notify the server 130 of the event end in operation 325. The user terminal 111 may determine whether a category selection for the core data is requested from the server 130 in operation 327. The user terminal 111 may output a guide message identifying that a POAP image is produced with the core data through the screen. The guide message may be, e.g., ‘We recommend a photo that best represents the event. Would you like to produce a POAP image with this photo?’ The user terminal 111 may display an identifier (e.g., emoticon or icon) for selecting a response to the guide message on the screen. The identifier may include “Change Image” and “Confirm.” In case that “Change Image” is selected by the user, the user terminal 111 may display candidate images prepared for producing a POAP image on the screen. The candidate image may be selected from among images captured at the same location, time zone, and/or subject as the image recommended by the server 130. The core data may include candidate images and analysis data for the candidate images. In this case, the user terminal 111 may select the candidate image considering the order of higher sum scores obtained by analysis.

In case that one image is selected from among the candidate images by the user, the user terminal 111 may display the selected candidate image enlarged on the screen. In case that the user selects the candidate image displayed enlarged, the user terminal 111 may determine to use the selected candidate image as the representative image. The user terminal 111 may display an identifier (e.g., emoticon or icon) on the screen so that the user may select whether to select the candidate image displayed enlarged as the representative image. The identifier may include “Cancel” and “Confirm.”

In case that “Confirm” is selected by the user, the user terminal 111 may display a predetermined guide message and identifiers for selecting a category of the selected representative image on the screen. The identifiers that may be displayed on the screen for selecting the category may include “Travel,” “Restaurant,” and “Exercise.” The user terminal 111 may display an identifier for the user to select whether to transmit information about the selected category to the server 130 on the screen. The identifier may include “Cancel” and “Confirm.”

In case that the user selects “Confirm,” the user terminal 111 may transmit the image selected as the representative image and/or information about the selected category to the server 130 in operation 329.

The user terminal 111 may determine whether a POAP image is received from the server 130 in operation 331. In case that the POAP image is received, the user terminal 111 may store and/or output the POAP image through the screen in operation 333.

In case of being not designated as the host terminal, the user terminal 111 may configure event-related data according to an activity of an attending member in the target event and transmit the event-related data to the server 130 in operation 341. The event-related data may be defined for each activity category in the target event. The activity category may be classified into, e.g., photo taking, content (e.g., movie or book) reservation or viewing, or the like. The event-related data may be as defined by Table 1 above. The user terminal 111 may continue to transmit event-related data to the server 130 until the end of the target event is determined.

The user terminal 111 may determine whether the end of attendance at the target event is requested by the user or whether the end of the target event is notified from the server 130 in operation 343. In case that the end of the target event is detected, the user terminal 111 may determine whether a POAP image is received from the server 130 in operation 345. The user terminal 111 may wait until the POAP image is received, terminate the operation according to a user's request, or move to another operation. The drawing is based on the premise of waiting. In case that the POAP image is received, the user terminal 111 may store and/or output the POAP image through the screen in operation 347.

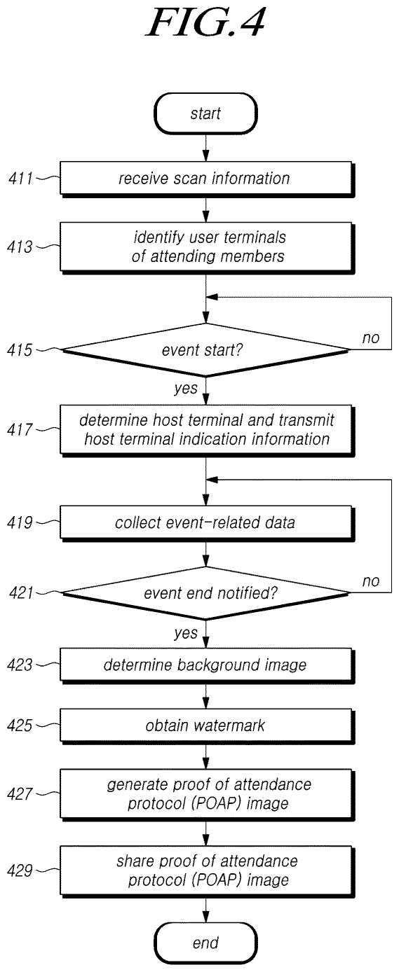

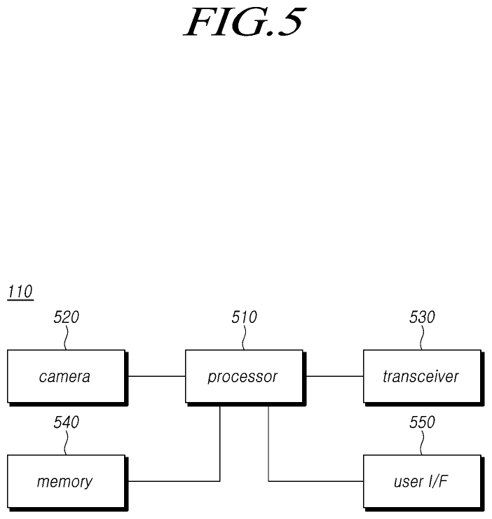

FIG. 4 is a flowchart illustrating example operations for issuing a POAP image at a server (e.g., server 130 of FIG. 1) according to various example embodiments.

Referring to FIG. 4, the server 130 may receive scan information transmitted by the user terminals 111, 112, 113, 114 in operation 411. The scan information may include information about an attendee terminal recognized as being nearby by the user terminals 111, 112, 113, 114 performing the scan operation. The information about the attendee terminal may include at least one of identification information of the corresponding attendee terminal or identification information of the corresponding attending member. The scan information may include information about the target event such as target event identification information.

The server 130 may identify attending members based on the scan information transmitted by the user terminals 111, 112, 113, 114 in operation 413. The identification of the attending members may be performed by recognizing a user terminal that attended the target event.

The server 130 may determine whether the target event starts in operation 415. The server 130 may determine that the target event will start at a time when, e.g., all user terminals corresponding to personnel to attend the target event are identified, or the start time of the target event arrives. In operation 415, the server 130 may wait until the target event starts, terminate without performing subsequent operations according to a user's request, or move to another operation. The drawing is based on the assumption that the server 130 waits until the target event starts.

The server 130 may determine the host terminal and transmit host terminal indication information according to the determination to the user terminals 111, 112, 113, 114 or the host terminal (e.g., the first user terminal 111 of FIG. 1) in operation 417. The server 130 may determine a host from among the identified attending members. The determination of the host may be determining the user terminal of the corresponding attending member as the host terminal. The server 130 may determine, e.g., a user terminal that first transmitted scan information as the host terminal. The server 130 may determine, e.g., a user terminal of an attending member who first registered the target event in their schedule as the host terminal. The server 130 may determine, e.g., a user terminal designated by the user terminals 111, 112, 113, 114 as the host terminal.

The server 130 may receive and store event-related data transmitted by the user terminals 111, 112, 113, 114 in operation 419. The event-related data may be defined for each activity category in the target event. The activity category may be classified into, e.g., photo taking, content (e.g., movie or book) reservation or viewing, or the like. The event-related data may be the same as described with reference to Table 1 above.

The server 130 may determine whether the end of the target event is notified from any one of the attendee terminals 112, 113, 114 or the host terminal 111 in operation 421.

In case of detecting the end of the target event, the server 130 may determine a background image based on the event-related data collected from the user terminals 111, 112, 113, 114 in operation 423.

For example, the server 130 may extract core data and obtain detailed context information for the extracted core data. The server 130 may obtain an image source for POAP production based on the detailed context information. The image source may refer, for example, to data for obtaining a background image from the representative image or generating a watermark.

The server 130 may generate the background image by editing the representative image selected from among images in which an attending member is captured. The server 130 may generate the background image by editing the representative image selected from among images in which an attending member is not captured. The server 130 may generate the background image by editing a poster of a viewed movie. The server 130 may generate the background image by editing an image capturing a main scene from a viewed movie. The server 130 may generate the background image by editing a cover image of a read book. The server 130 may generate the background image by editing an image of a music album cover.

The server 130 may obtain a watermark in operation 425. The watermark enables a POAP image to be produced by the server 130 to serve as a certificate certifying attendance at the target event.

For example, the server 130 may determine a watermark using a character image owned as an NFT by at least one attending member captured in the representative image. The character image may be produced by reflecting attire, a pose, or a facial expression of an attending member included in the image. The facial expression and/or pose of the character image may be produced by reflecting mood keyword information derived as detailed context information.

The server 130 may determine a watermark using a character image obtained by reflecting mood keyword information derived as the detailed context information. For example, the character image may be produced by reflecting a suitable pose and/or facial expression based on the mood keyword information.

In case that the image used as the representative image is a movie poster or a capture image, the server 130 may determine one of the character images of attending members as a watermark by considering similarity with a person or character included in the movie poster or the capture image. The character image determined as the watermark may be selected from among character images owned as an NFT by attending members considering a facial expression, a posture, or attire of a person or character included in the movie poster or the capture image.

In case that the image used as the representative image is a movie poster or a capture image, the server 130 may determine a character image easy to synthesize with a person or character included in the movie poster or the capture image as a watermark from among character images owned as an NFT by attending members.

The server 130 may determine a character image matching a facial expression or gesture predictable from content selected or captured from a book by an attending member, or text or a hashtag added in case of uploading to SNS as the watermark from among character images owned as an NFT by attending members.

In case that a logo for the target event is present, the server 130 may extract the corresponding logo as an image, edit a background area of the extracted logo image to be transparent, and obtain only the logo part as a watermark.

The server 130 may collect information about the target event and extract text or a logo corresponding to a location, time, exercise record, content name, or an occasion title hosted by an organization based on the collected information. The server 130 may obtain a watermark using the extracted record text or logo.

The server 130 may generate a POAP image based on image synthesis of placing at least one watermark on the background image in operation 427. In an example, the server 130 may synthesize a character image as a watermark on the background image considering a position of an attending member in the representative image. In an example, the server 130 may synthesize the character image as a watermark on the background image considering a pose or a facial expression of the character image. In an example, the server 130 may synthesize a logo image as a watermark on the background image. In an example, the server 130 may synthesize record text as a watermark on the background image. In an example, the server 130 may synthesize a character image and a logo image as a watermark on the background image. In an example, the server 130 may synthesize a character image and an emblem image as a watermark on the background image. In an example, the server 130 may synthesize a character image and record text as a watermark on the background image. In an example, the server 130 may synthesize a character image, a logo image, and an emblem image as a watermark on the background image. In an example, the server 130 may synthesize a character image, a logo image, and record text as a watermark on the background image. In an example, the server 130 may synthesize a character image, an emblem image, and record text as a watermark on the background image. In an example, the server 130 may synthesize a logo image and an emblem image as a watermark on the background image. In an example, the server 130 may synthesize a logo image, an emblem image, and record text as a watermark on the background image.

For sharing of the POAP image, the server 130 may transmit the POAP image to the user terminals 111, 112, 113, 114 or the host terminal 111 in operation 429.

FIG. 5 is a block diagram illustrating an example configuration of a user terminal (e.g., user terminals 111, 112, 113, 114 of FIG. 1) according to various example embodiments. Hereinafter, the description is based on the assumption that the operations are performed by one user terminal 111 among the user terminals 111, 112, 113, 114, but the remaining user terminals may also be capable of performing the same operation.

Referring to FIG. 5, the user terminal 111 may include at least one processor (e.g., including processing circuitry) 510, a camera 520, a transceiver 530, at least one memory 540, and/or a user interface (I/F) (e.g., including various circuitry) 550.

The processor 510 may be implemented as one or more integrated circuit (IC) chips and may perform various data processing. For example, the processor 510 (or an application processor (AP)) may be implemented as a system on chip (SoC) (e.g., one chip or chipset). The processor 510 may include sub components including a central processing unit (CPU), a graphics processing unit (GPU), a neural processing unit (NPU), an image signal processor (ISP), a display controller, a memory controller, a storage controller, a communication processor (CP), and/or a sensor interface. The sub components are merely examples. For example, processor 510 may further include other sub components. For example, some sub components may be omitted from the processor 510. For example, some sub components may be included as separate components of the user terminal 111 outside the processor 510. For example, some sub components may be included in other components (e.g., a display and an image sensor).

The processor 510 (e.g., a CPU or a central processing circuit) may be configured to control sub components based on execution of instructions stored in the memory 540 (e.g., a volatile memory and/or a non-volatile memory). The GPU (or the graphics processing circuit) may be configured to execute parallel computations (e.g., rendering). The NPU (or neural processing circuit) may be configured to execute operations (e.g., convolution computations) for an artificial intelligence model. The ISP (or image signal processing circuit) may be configured to process a raw image obtained through an image sensor into a format suitable for a component in the user terminal 111 or a sub component in the processor 510. The display controller (or the display control circuit) may be configured to process an image obtained from the CPU, the GPU, the ISP, or the memory 540 (e.g., a volatile memory) into a format suitable for projection onto the projection surface. The memory controller (or the memory control circuit) may be configured to control to read data from the volatile memory and write the data to the volatile memory. The storage controller (or the storage control circuit) may be configured to read data from the non-volatile memory and control to write the data to the non-volatile memory. The CP (communication processing circuit) may be configured to process data obtained from a sub component in the processor 510 into a format suitable for transmission to another electronic device (e.g., server 130 of FIG. 1) through the transceiver 530, or to process data obtained through the transceiver 530 from another electronic device (e.g., server 130 of FIG. 1) into a format suitable for processing by a sub component. The sensor interface (or sensing data processing circuit, sensor hub) may be configured to process data about a state of the user terminal 111 and/or a state of surroundings of the user terminal 111 obtained through an internal sensor (e.g., a distance measurement sensor (time-of-flight (ToF) sensor)) or an external sensor (e.g., one or more position measurement sensors (anchor)) into a format suitable for a sub component in the processor 510. Thus, the processor 510 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The camera 520 may capture still images and videos. The camera 520 may include one or more lenses, image sensors, image signal processors, or flashes.

The transceiver 530 may include various communication circuitry and be configured to exchange information with at least one electronic device (e.g., user terminals 112, 113, 114 of FIG. 1 or server 130 of FIG. 1). The transceiver 530 may transmit/receive data or a signal with other user terminals 112, 113, 114 or the server 130 under the control of the processor 510. The transceiver 530 may include a Bluetooth communication unit, a Bluetooth low energy (BLE) communication unit, a near field communication unit, a wireless local area network (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or a microwave (uWave) communication unit corresponding to the performance and structure of the user terminal 111, but the disclosure is not limited thereto.

The transceiver 530 may support establishment of a direct (e.g., wired) communication channel or a wireless communication channel with at least one other user terminal 112, 113, 114 or the server 130 and communication performance through the established communication channel. The transceiver 530 may include one or more communication processors supporting direct (e.g., wired) communication or wireless communication. The one or more communication processors may be operated independently of the processor 510. The transceiver 530 may include, e.g., a wireless communication module (e.g., a cellular communication module, a short-range wireless communication module, or a global navigation satellite system (GNSS) communication module) or a wired communication module (e.g., a local area network (LAN) communication module or a power line communication module). A corresponding one of these communication modules may communicate with an external electronic device, via a network (e.g., a short-range communication network, such as Bluetooth™, wireless-fidelity (Wi-Fi) direct, or infrared data association (IrDA)) or a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

The memory 540 may store various data (e.g., instructions) used by at least one component (e.g., the processor 510) of the user terminal 110. The various data may include, for example, software (e.g., the program) and input data or output data for a command related thereto. The memory 540 may include a volatile memory or a non-volatile memory.

The user I/F 550 may include various circuitry and be configured to receive information from the user. For example, the user I/F 550 may generate a command or data to be used by a component (e.g., at least one processor 510) of the user terminal 110 in response to a user's manipulation. The user I/F 550 may include, e.g., a touch panel, a microphone, a mouse, a keyboard, a key (e.g., button), or a digital pen (e.g., stylus pen).

The user I/F 550 may be configured to transmit information to the user. For example, the user I/F 550 may output sound signals to the outside. The user I/F 550 may include, e.g., a display, a speaker, or a receiver. The display may output visual information to the user as a screen. The speaker may be used for general purposes, such as playing multimedia or playing record. The receiver may be used for receiving incoming calls. The receiver may be implemented as separate from, or as part of the speaker.

According to an example, the processor 510 may control the transceiver 530 to perform an attending member scan. In an example, the processor 510 may discover a user terminal holding an NFT issued for the target event from among peripheral user terminals located within a predetermined distance. The NFT may be a POAP token.

The processor 510 may transmit scan information to a server (e.g., server 130 of FIG. 1) through the transceiver 530. The scan information may include information about an attendee terminal. The information about the attendee terminal may include at least one of identification information of the corresponding attendee terminal or identification information of the corresponding attending member. The scan information may include information about the target event such as target event identification information. The processor 510 may transmit scan information each time an attendee terminal is identified, or collectively transmit scan information about all attendee terminals identified at a time when the target event starts.

The processor 510 may determine whether the start of the target event and the host terminal are determined. If the host terminal 111 is designated before the scan operation is performed, the processor 510 may perform the scan operation to determine the start of the target event.

In case of being designated as the host terminal, the processor 510 may perform an operation as the host terminal. In case of being not designated as the host terminal, the processor 510 may perform an operation as an attendee terminal.

The processor 510 may configure event-related data according to an activity of an attending member in the target event. The event-related data may be defined for each activity category in the target event. The activity category may be classified into, e.g., photo taking, content (e.g., movie or book) reservation or viewing, or the like. The event-related data may be as defined by Table 1 above. The processor 510 may configure the event-related data using an image captured through the camera 520. The processor 510 may configure the event-related data using information input through the user I/F 550. The processor 510 may configure the event-related data using an image captured through the camera 520 and information input through the user I/F 550.

The processor 510 may control the transceiver 530 to transmit the event-related data to the server 130. The processor 510 may control the transceiver 530 to continue to transmit event-related data to the server 130 until the end of the target event is determined.

The processor 510 may monitor whether an attendee terminal is present nearby by performing the scan operation periodically or aperiodically while the target event is in progress. The processor 510 may determine the end of the target event based on, e.g., an attendee terminal no longer being scanned nearby, or the number of attendee terminals being less than a predetermined threshold level. The processor 510 may notify the server 130 of the event end.

The processor 510 may determine whether a category selection for the core data is requested from the server 130. The processor 510 may output a guide message identifying that a POAP image is produced with the core data through a display included in the user I/F 550. The processor 510 may control the display to output candidate images in response to a user's request. The processor 510 may identify a candidate image selected by the user from among the candidate images. The processor 510 may control the display to output categories to be suggested for the identified candidate image. In case that one of the categories is selected by the user, the processor 510 may transmit information about the selected category to the server 130 through the transceiver 530.

The processor 510 may receive a POAP image from the server 130 through the transceiver 530. In case that the POAP image is received, the processor 510 may store the POAP image in the memory 540 or output the POAP image through the display.

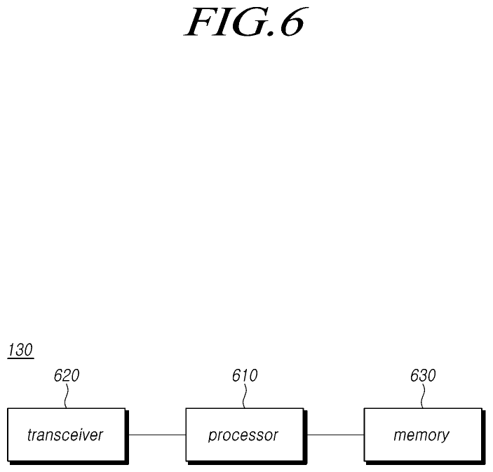

FIG. 6 is a block diagram illustrating an example configuration of a server (e.g., server 130 of FIG. 1) according to various example embodiments.

Referring to FIG. 6, the server 130 may include at least one processor (e.g., including processing circuitry) 610, a transceiver 620, and/or at least one memory 630. The server 130 may further include components not illustrated (e.g., a display or a sensor).

The processor 610 may be implemented as one or more IC chips and may execute various data processing operations. For example, the processor 610 may be implemented as an SoC (e.g., one chip or chipset). The processor 610 may include sub components including a CPU, a GPU, an NPU, an ISP, a display controller, a memory controller, a storage controller, a CP, and/or a sensor interface. The sub components are merely examples. The processor 610 may further include other sub components, or some sub components may be omitted. For example, some sub components may be included as separate components of the server 130 outside the processor 610. For example, some sub components may be included in other components (e.g., a display and an image sensor).

The processor 610 may be configured to control the sub components based on execution of instructions stored in the memory 630 (e.g., volatile memory and/or non-volatile memory). The processor 610 may be configured to execute parallel operations (e.g., rendering). The processor 610 may be configured to execute operations (e.g., convolution computation) for an artificial intelligence model. The processor 610 may be configured to process a raw image obtained through an image sensor into a format suitable for a component in the server 130 or a sub component in the processor 610. The processor 610 may be configured to edit or process an obtained image into a desired format. The processor 610 may be configured to control reading data from the volatile memory or writing data thereto. The processor 610 may be configured to process data obtained from a sub component into a format suitable for transmission to another electronic device (e.g., user terminals 111, 112, 113, 114 of FIG. 1) through the transceiver 620, or to process data obtained through the transceiver 620 from another electronic device (user terminals 111, 112, 113, 114) into a format suitable for processing by a sub component. The description of the processor 510 above applies equally to the processor 610, and thus a detailed description may not be repeated here.

The transceiver 620 may include various communication circuitry and be configured to exchange information with at least one electronic device (e.g., user terminals 111, 112, 113, 114 of FIG. 1). The transceiver 620 may transmit/receive data or a signal with the user terminals 111, 112, 113, 114 under the control of the processor 610. The transceiver 620 may include a Bluetooth communication unit, a BLE communication unit, a near field communication unit, a WLAN communication unit, a Zigbee communication unit, an IrDA communication unit, a WFD communication unit, a UWB communication unit, an Ant+ communication unit, or a uWave communication unit corresponding to the performance and structure of the server 130, but the disclosure is not limited thereto.

The transceiver 620 may support establishment of a direct (e.g., wired) communication channel or a wireless communication channel with the user terminal 111, 112, 113, 114 and communication performance through the established communication channel. The transceiver 620 may include one or more communication processors supporting direct (e.g., wired) communication or wireless communication. The one or more communication processors may be operated independently of the processor 610. The transceiver 620 may include, e.g., a wireless communication module (e.g., a cellular communication module, a short-range wireless communication module, or a GNSS communication module) or a wired communication module (e.g., a LAN communication module, or a power line communication module). A corresponding communication module among these communication modules may communicate with at least one user terminal 111, 112, 113, 114 being an external electronic device through a network (e.g., a short-range communication network such as Bluetooth, Wi-Fi direct, or IrDA, or a long-range communication network such as a legacy cellular network, a 5G network, a next-generation communication network, the Internet, or a computer network (e.g., LAN or WAN)). These various types of communication modules may be implemented as a single component (e.g., a single chip), or may be implemented as multi components (e.g., multi chips) separate from each other.

The memory 630 may store various data (e.g., instructions) used by at least one component (e.g., the processor 610) of the server 130. The various data may include, for example, software (e.g., the program) and input data or output data for a command related thereto. The memory 630 may include a volatile memory or a non-volatile memory.

According to an example, the processor 610 may identify user terminals (e.g., user terminals 111, 112, 113, 114 of FIG. 1) of attending members who attended the target event from among enrolled members based on an NFT issued for a predetermined gathering. For identification of the user terminals 111, 112, 113, 114, the processor 610 may receive scan information from the user terminals 111, 112, 113, 114.

The processor 610 may determine a host for the target event from among the attending members. The processor 610 may control the transceiver 620 to receive event-related data generated by the user terminals 111, 112, 113, 114. The event-related data may include at least one of a video captured by the user terminals 111, 112, 113, 114, metadata of the captured video, ambient sound recorded at a time of video capture, schedule information, or a usage record of an application program.

The processor 610 may determine a background image corresponding to the target event based on the event-related data. In an example, the processor 610 may analyze the event-related data to extract core data related to the target event. The processor 610 may control the transceiver 620 to transmit the core data to the host terminal 111. The processor 610 may include at least one candidate image to be recommended as the background image in the core data. The processor 610 may control the transceiver 620 to receive a category identifier corresponding to the core data from the host terminal 111. The category identifier may include identification information indicating use as the background image from among the at least one candidate image. The processor 610 may obtain detailed context information for the core data based on the category identifier. The processor 610 may determine a background image corresponding to the target event based on the event-related data and/or the detailed context information. The processor 610 may delete an attending member image included in the background image.

The processor 610 may obtain a character image designed to match the background image as a watermark based on a character owned as an NFT by at least one selected attending member among the attending members and/or the collected event-related data. The at least one selected attending member may be determined from, e.g., at least one attending member included in the background image. The at least one selected attending member may be determined by considering similarity to the background image from among the attending members based on, e.g., the event-related data. The processor 610 may determine attire, a pose, or a facial expression of at least one character based on the detailed context information, and obtain the character image by reflecting the determined attire, pose, or facial expression. The processor 610 may obtain a watermark based on an emblem, a logo, and/or text corresponding to the target event or the predetermined gathering that hosted the target event.

The processor 610 may generate a POAP image certifying attendance at the event by synthesizing the watermark on the background image. The processor 610 may control the transceiver 620 to transmit the POAP image to the user terminals 111, 112, 113, 114. The processor 610 may control the transceiver 620 to transmit the POAP image to the host terminal 111.

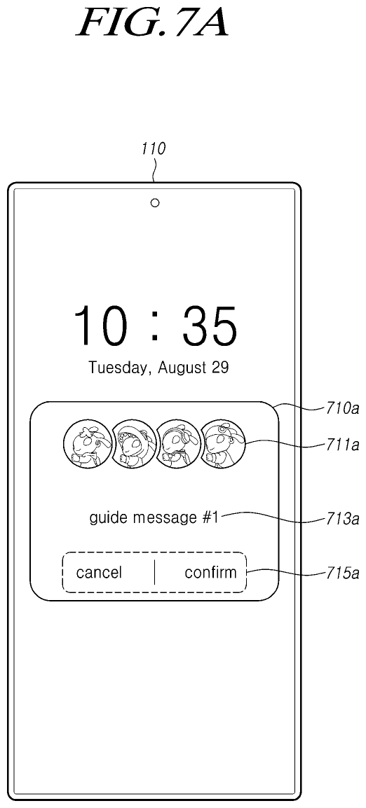

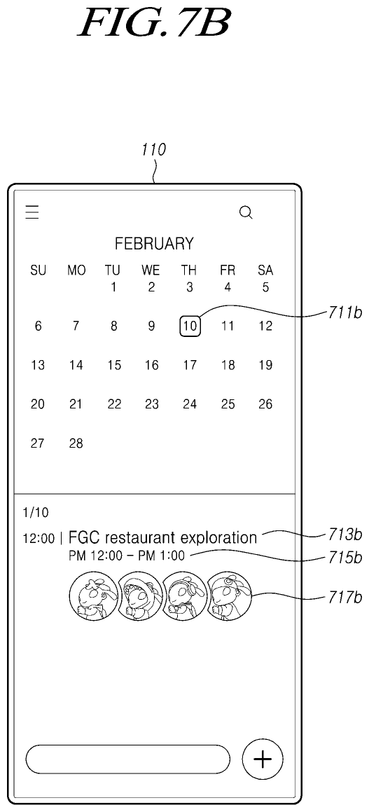

FIG. 7A is a diagram illustrating an example of a pop-up of a scan notification message at a user terminal 110 according to various example embodiments. The user terminal 110 may be a specific user terminal included in the user terminals 111, 112, 113, 114 of FIG. 1.

Referring to FIG. 7A, the user terminal 110 may perform a scan operation to discover an attendee terminal. The attendee terminal may be a user terminal of another attending member to attend the target event except for itself. The user terminal 110 may identify one or more attendee terminals through the scan operation. In an example, the user terminal 110 may output a character 711a of the identified attendee terminal and/or a guide message #1 713a through a display 710a. The guide message #1 713a may be, e.g., “The attending members have gathered! Shall we automatically generate a POAP to commemorate the event?”

The user terminal 110 may output an identifier (e.g., emoticon or icon) 715a selectable by the user in response to the guide message #1 713a through the display 710a. The identifier may be, e.g., “Cancel” or “Confirm.” In an example, if the user first selected “Confirm” among attending members of the target event, the user terminal 110 may be set as the host terminal to host the target event.

FIG. 7B is a diagram illustrating an example of managing an event schedule at a user terminal 110 according to various example embodiments. The user terminal 110 may be a specific user terminal included in the user terminals 111, 112, 113, 114 of FIG. 1.

Referring to FIG. 7B, the user terminal 110 may register a title 713b, a schedule (e.g., date, time, etc.) 711b, 715b, a location, and/or attendees 717b of an event to attend in a schedule management application program (e.g., calendar app) according to a user's request. The user terminal 110 may identify an attendee terminal being a user terminal of an attending member 717b registered as an attendee through the scan operation at the title 713b, the schedule 711b, 715b, and the location of the registered event. If the user terminal 110 first registered the schedule in relation to the target event, the user terminal 110 may be set as the host terminal to host the target event.

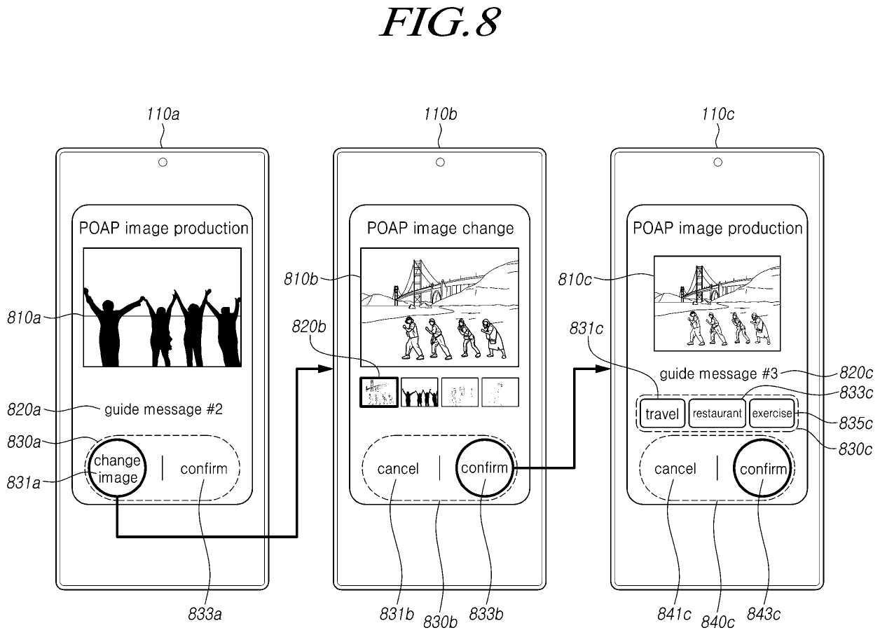

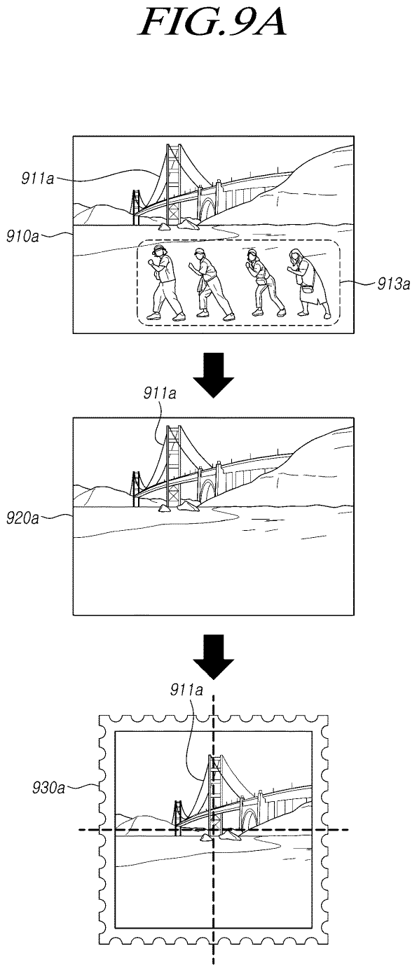

FIG. 8 is a diagram illustrating an example of selecting a representative image for POAP generation to certify attendance at a target event at a user terminal 110a, 110b, 110c according to various example embodiments. The user terminal 110a, 110b, 110c may be the host terminal included in the user terminals 111, 112, 113, 114 of FIG. 1.

Referring to FIG. 8, the user terminal 110a may receive core data related to the target event from a server (e.g., server 130 of FIG. 1). The user terminal 110a may output a representative image 810a included in the core data through a display. The representative image 810a may be an image recommended by the server 130 for POAP generation. In an example, the user terminal 110a may output a guide message #2 820a for notifying that the representative image has been suggested for POAP generation through the display. The guide message #2 820a may be, e.g., “This is the representative image to certify attendance at this event. Would you like to produce a POAP with the representative image?”

The user terminal 110a may output an identifier (e.g., emoticon or icon) 830a selectable by the user in response to the guide message #2 820a through the display. The identifier may be, e.g., “Change Image 831a” or “Confirm 833a.”

In case that the user selects “Change Image 813a,” the user terminal 110b may output a screen for suggesting an option to change through the display. The screen may include candidate images from which the representative image may be selected. The candidate images may be determined considering priority. The priority may be allocated as 1st priority to, e.g., an image captured at the same location and/or time zone as the recommended representative image, or an image capturing the same subject (e.g., subject) as the recommended representative image. The priority may be allocated as 2nd priority based on, e.g., a score allocated for selecting the core data.

In case that the user selects one 820b of the candidate images, the user terminal 110b may display the selected candidate image enlarged 810b. The user terminal 110b may output an identifier (e.g., emoticon or icon) 830b selectable by the user for selecting the candidate image 810b displayed enlarged as the representative image through the display. The identifier may be, e.g., “Cancel 831b” or “Confirm 833b.”

In case that the user selects “Confirm,” the user terminal 110c may output the selected candidate image 810c and/or a guide message #3 820c inquiring about a category of an event for which the selected candidate image 810c is used as the representative image through the display. The guide message #3 820c may be, e.g., “Please select a category of the event you attended.” The user terminal 110c may output an identifier (e.g., emoticon or icon) 830c selectable by the user in response to the guide message #3 820c through the display. The identifier 830c may be, e.g., “Travel 831c,” “Restaurant 833c,” and/or “Exercise 835c.” The user terminal 110c may output an identifier (e.g., emoticon or icon) 840c selectable by the user for finally identifying the selected category (e.g., Travel 831c) through the display. The identifier 840c may be, e.g., “Cancel 841c” or “Confirm 843c.” If the user has selected “Confirm 843c,” the user terminal 110c may transmit information about the selected category to the server 130.

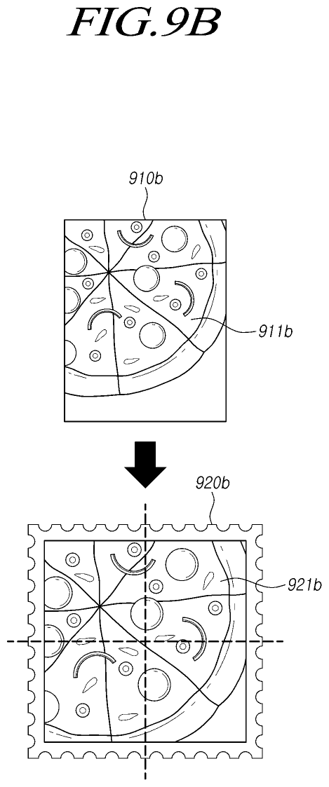

FIGS. 9A and 9B are diagrams illustrating examples of generating a background image for POAP generation at a server (e.g., server 130 of FIG. 1) according to various example embodiments.

Referring to FIG. 9A, in case that an attending member is captured in a representative image 910a, the server 130 may delete an image 913a of the attending member from the representative image 910a. The server 130 may generate a background image 930a by editing the representative image 920a from which the image of the attending member is deleted based on a core subject (e.g., a bridge among subjects included in the image) 911a capable of certifying attendance at the target event.

Referring to FIG. 9B, in case that an attending member is not captured in a representative image 910b, the server 130 may generate a background image 920b by editing the representative image 910b based on a core area (e.g., food included in the image) 911b or 921b capable of certifying attendance at the target event.

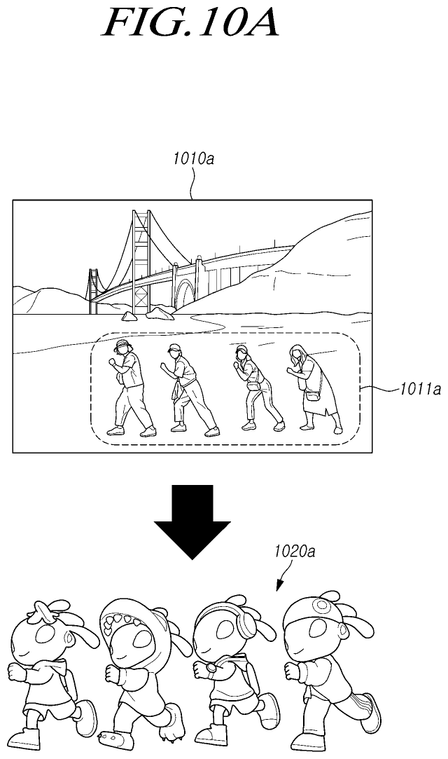

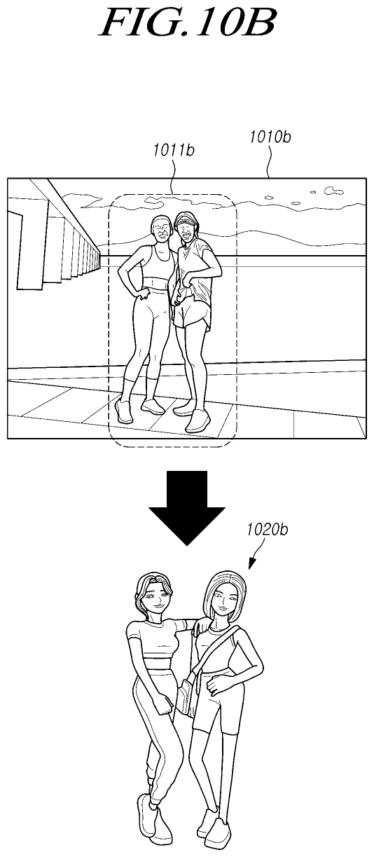

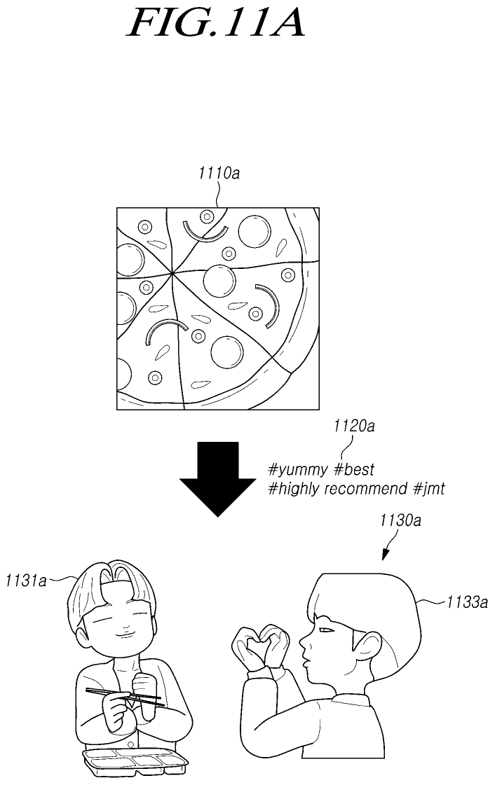

FIGS. 10A and 10B are diagrams illustrating examples of determining a watermark to certify attendance at a target event in case of generating a POAP image at a server (e.g., server 130 of FIG. 1) according to various example embodiments.

Referring to FIGS. 10A and 10B, in case that an attending member is captured in a representative image 1010a or 1010b, the server 130 may obtain a character 1020a or 1020b owned as an NFT by the captured attending member. The server 130 may edit or select attire, a facial expression, and/or a pose of the obtained character 1020a or 1020b based on information such as a mood of the attending member captured in the representative image. The server 130 may generate a POAP image by synthesizing a character image 1020a or 1020b of the attire, facial expression, and/or pose as a watermark on the background image in place of an attending member image 1011a or 1011b.

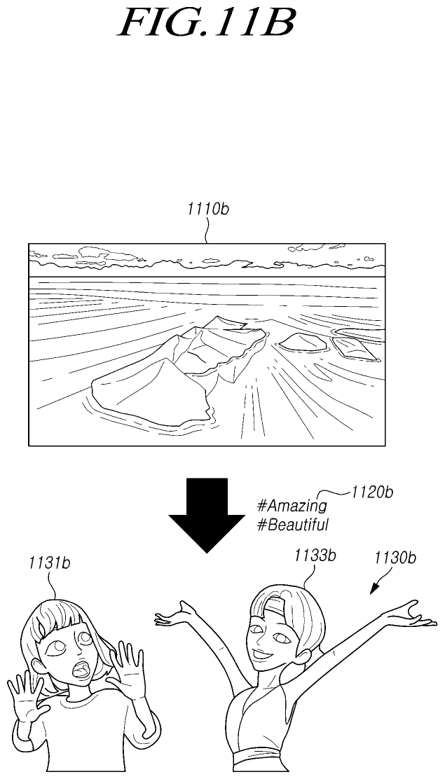

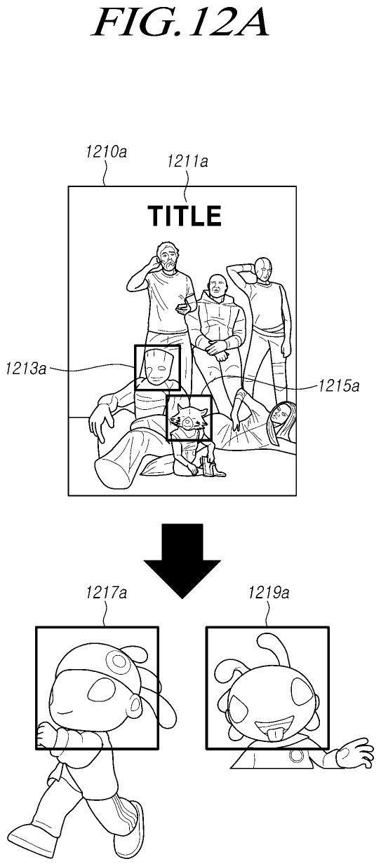

FIGS. 11A and 11B are diagrams illustrating examples of determining a watermark to certify attendance at a target event in case of generating a POAP image at a server (e.g., server 130 of FIG. 1) according to various example embodiments.

Referring to FIGS. 11A and 11B, in case that an attending member is not captured in the representative image, the server 130 may determine a character image 1130a or 1130b of attire, a facial expression, and/or a pose suitable for a background image 1110a or 1110b by considering a mood keyword (e.g., “#yummy #best #highly recommend #jmt 1120a” or “#Amazing #Beautiful 1120b”) corresponding to the representative image from among characters owned as an NFT by attending members. The server 130 may generate a POAP image by synthesizing the determined character image 1131a, 1133a or 1131b, 1133b as a watermark on the background image 1110a or 1110b.

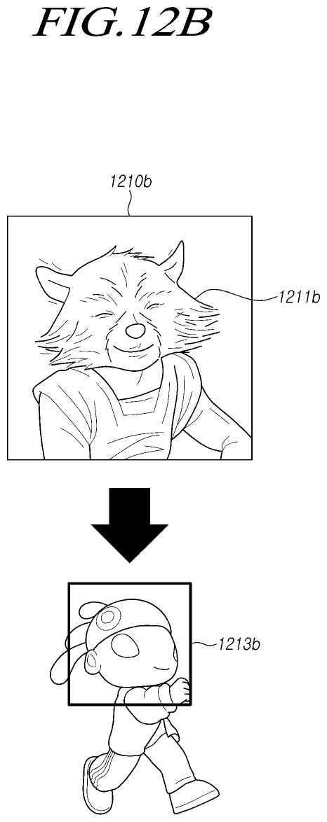

FIGS. 12A and 12B are diagrams illustrating examples of determining a watermark to certify attendance at a target event in case of generating a POAP image at a server (e.g., server 130 of FIG. 1) according to various example embodiments.

Referring to FIGS. 12A and 12B, in case that the target event is movie viewing, the server 130 may select a target object (e.g., character or cast member) 1213a, 1215a or 1211b included in a movie poster or a capture image of a main scene from the movie. The server 130 may determine a suitable character image 1217a, 1219a or 1213b by considering similarity (e.g., attire, facial expression, and/or pose) with the selected target object 1213a, 1215a or 1211b from among characters owned as an NFT by attending members. The server 130 may determine a background image 1210a or 1210b using the movie poster or the capture image, and generate a POAP image by synthesizing the determined character image 1217a, 1219a or 1213b as a watermark on the background image 1210a or 1210b.

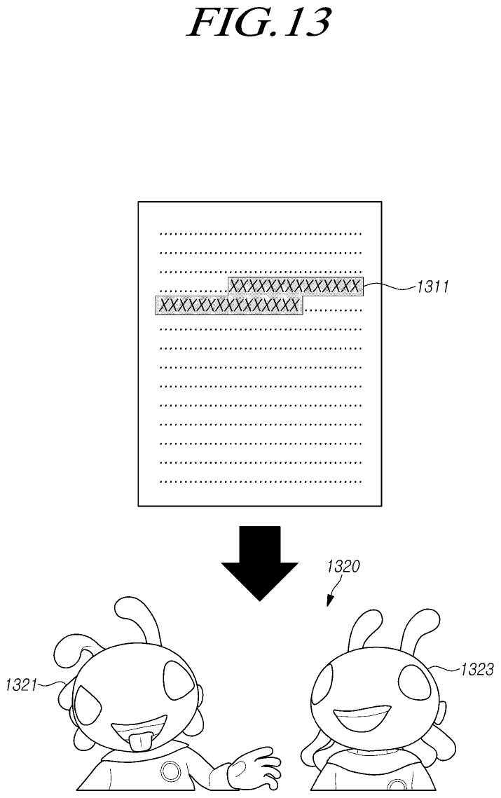

FIG. 13 is a diagram illustrating an example of determining a watermark to certify participation in a target event in case of generating a POAP image at a server (e.g., server 130 of FIG. 1) according to various example embodiments.

Referring to FIG. 13, in case that the target event is reading, the server 130 may obtain mood information predictable from a word or the like in a passage 1311 that a participant has bookmarked (e.g., underlined or highlighted). The server 130 may determine a suitable character image 1320 by considering similarity (e.g., attire, facial expression, and/or pose) with the content of the passage 1311 based on the mood information from among characters owned as an NFT by attending members. The server 130 may determine a background image using a cover image of the target book, and generate a POAP image by synthesizing the determined character image 1321, 1323 on the background image.

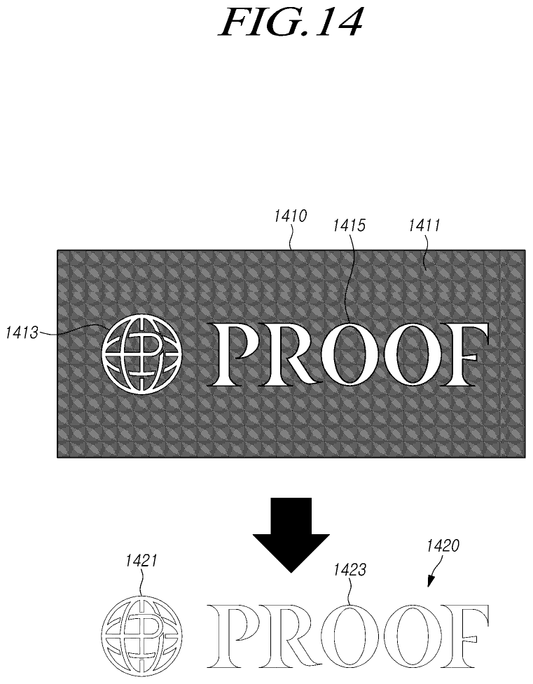

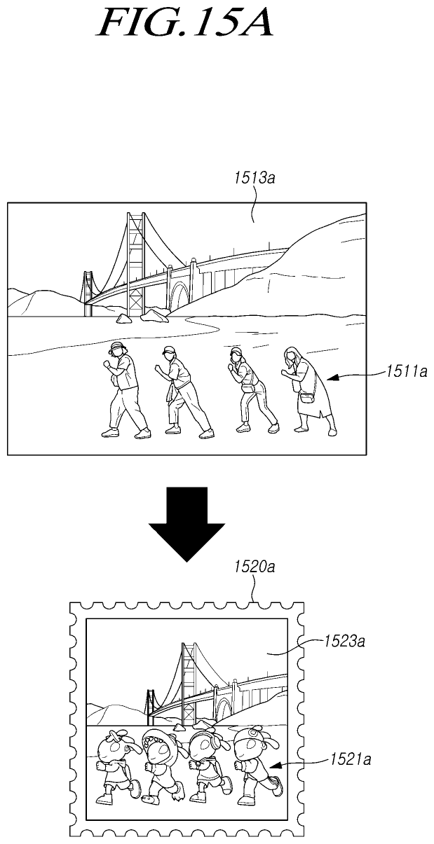

FIG. 14 is a diagram illustrating an example of determining a watermark to certify participation in a target event in case of generating a POAP image at a server (e.g., server 130 of FIG. 1) according to various example embodiments.

Referring to FIG. 14, the server 130 may obtain a logo image 1410 symbolizing the target event or gathering from an internal database and/or an external database. The server 130 may obtain a logo 1413 and/or text 1415 by processing a background image 1411 of the logo image 1410 to be transparent or removing it. The server 130 may generate a watermark 1420 using the obtained logo 1413 and/or text 1415. The watermark 1420 may include a logo 1421 and/or text 1423. The server 130 may generate a POAP image by synthesizing the watermark 1420 on a background image.

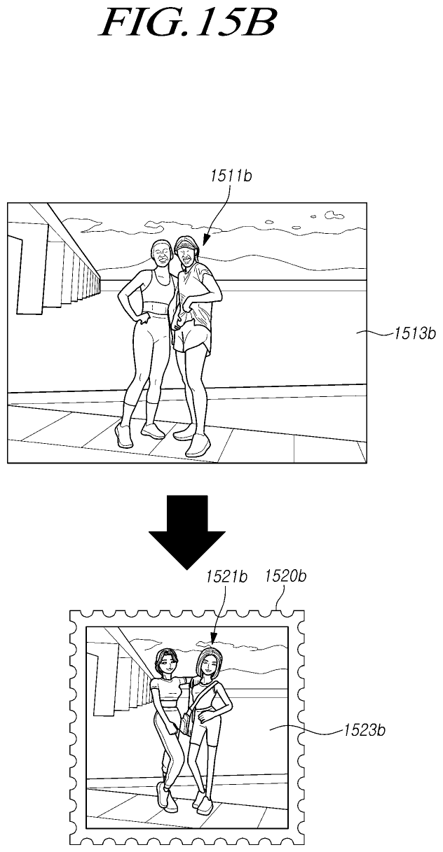

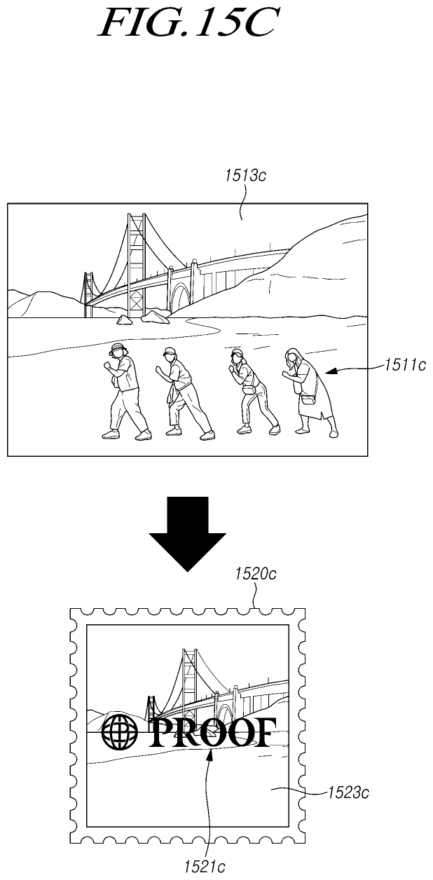

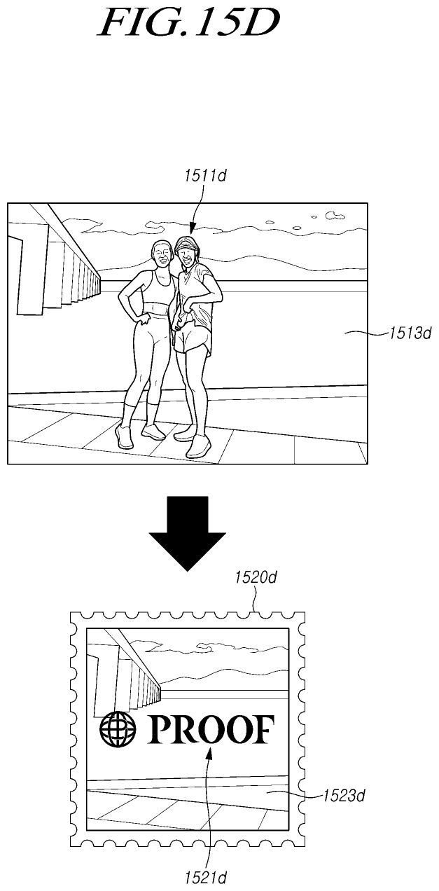

FIGS. 15A, 15B, 15C and 15D are diagrams illustrating examples of generating a POAP image at a server (e.g., server 130 of FIG. 1) according to various example embodiments.

Referring to FIGS. 15A and 15B, the server 130 may produce or generate a POAP image 1520a or 1520b by synthesizing a character image 1521a or 1521b to replace an attendee image 1511a or 1151b on a background image 1523a or 1523b from which the attendee image 1511a or 1511b is deleted from a representative image 1513a or 1513b.

Referring to FIGS. 15C and 15D, the server 130 may produce or generate a POAP image 1520c or 1520d by synthesizing a watermark 1521c or 1521d including a logo and/or text to replace an attendee image 1511c or 1511d on a background image 1523c or 1523d from which the attendee image 1511c or 1511d is deleted from a representative image 1513c or 1513d.

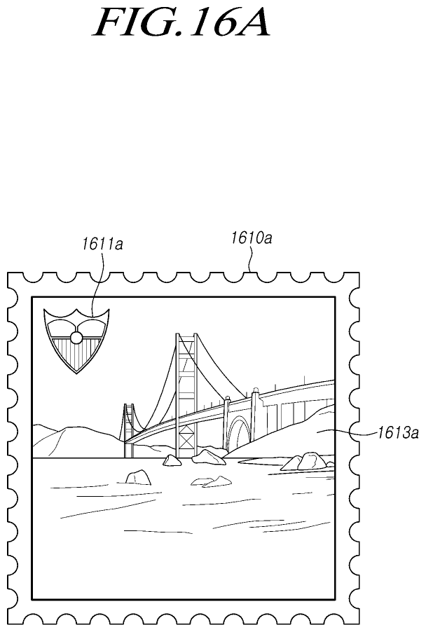

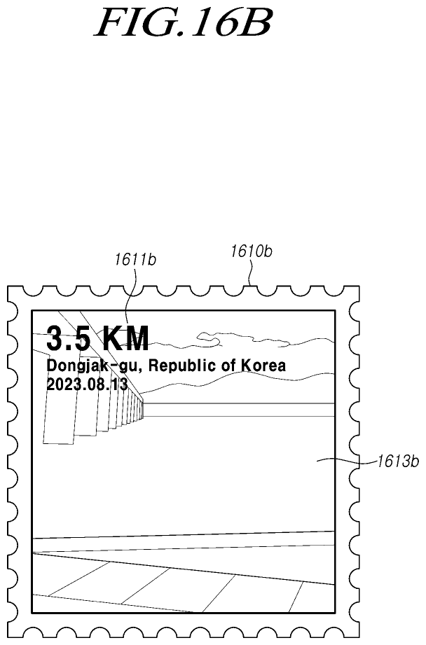

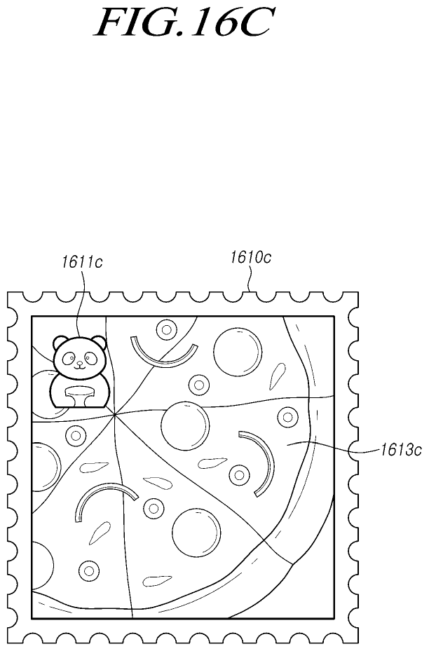

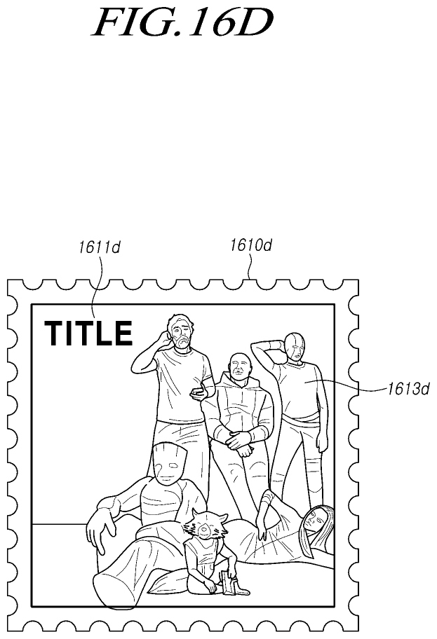

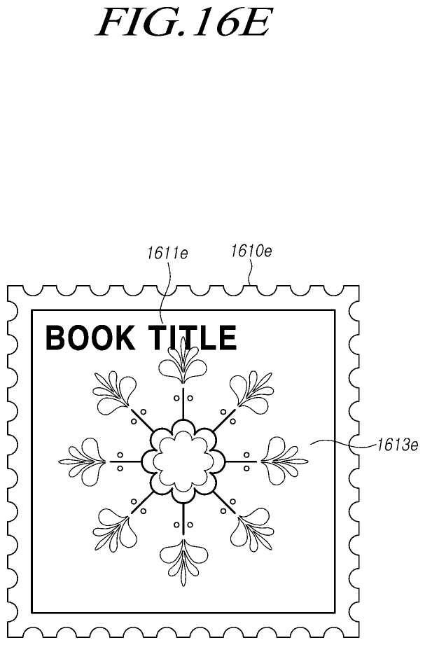

FIGS. 16A, 16B, 16C, 16D and 16E are diagrams illustrating examples of generating a POAP image using a watermark symbolizing a category of a representative image at a server (e.g., server 130 of FIG. 1) according to various example embodiments.

Referring to FIGS. 16A through 16E, in an example, in case that the category of the representative image is determined as “location,” the server 130 may generate a POAP image 1610a by synthesizing an emblem 1611a symbolizing the location on a background image 1613a (see FIG. 16A).

In an example, in case that the category of the representative image is determined as “exercise,” the server 130 may generate a POAP image 1610b by synthesizing text 1611b representing an exercise record on a background image 1613b (see FIG. 16B).

In an example, in case that the category of the representative image is determined as “food,” the server 130 may generate a POAP image 1610c by synthesizing a logo 1611c symbolizing a restaurant or store on a background image 1613c (see FIG. 16C).

In an example, in case that the category of the representative image is determined as “content,” the server 130 may generate a POAP image 1610d by synthesizing text 1611d representing a content title on a background image 1613d (see FIG. 16D).

In an example, in case that the category of the representative image is determined as “book,” the server 130 may generate a POAP image 1610e by synthesizing text 1611e representing a book name on a background image 1613e (see FIG. 16E).

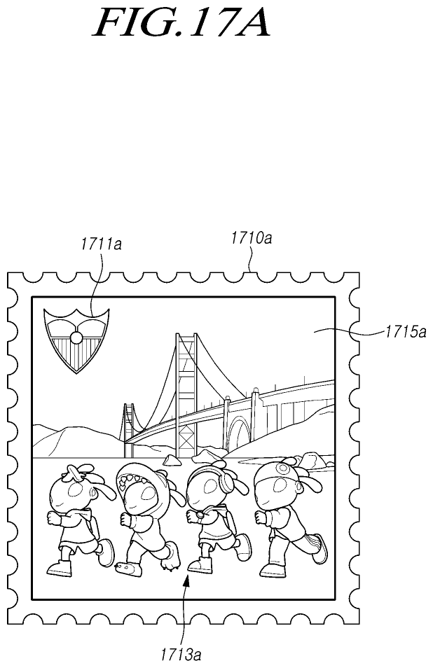

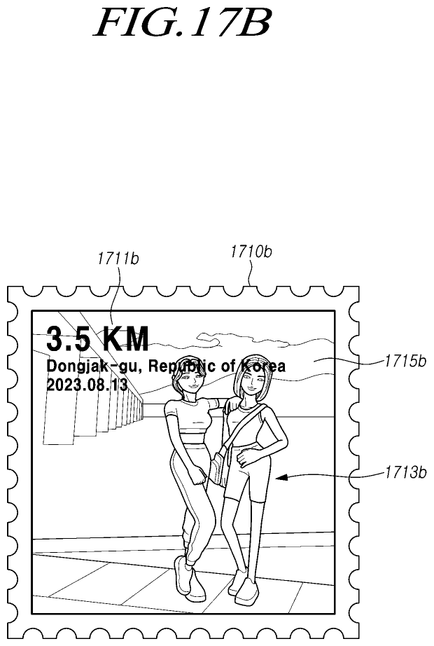

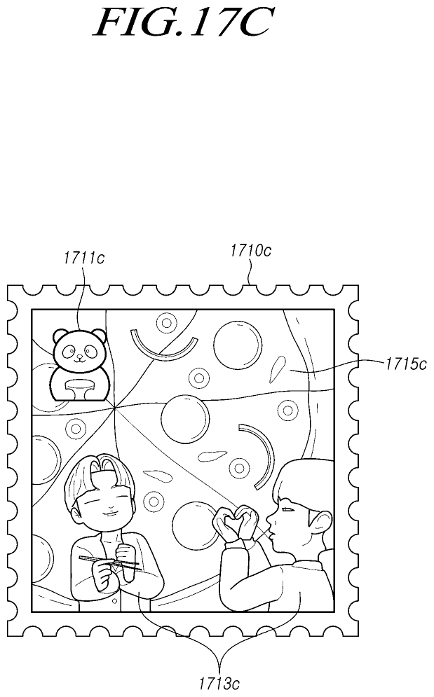

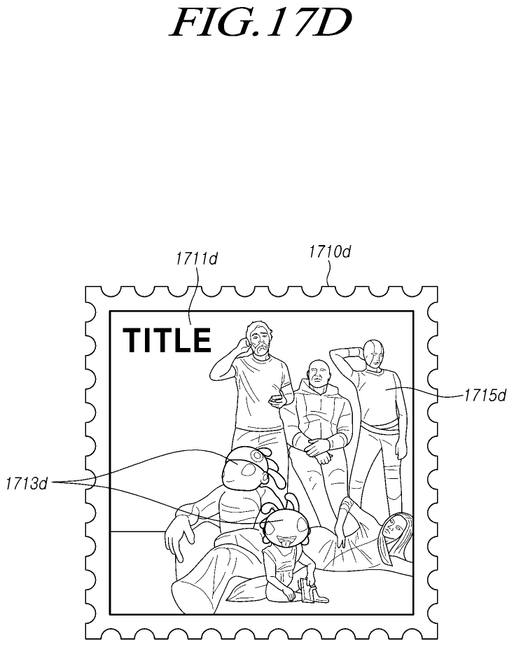

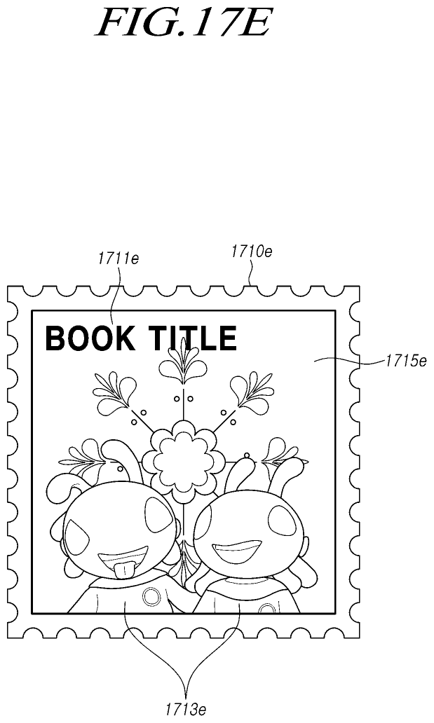

FIGS. 17A, 17B, 17C, 17D and 17E are diagrams illustrating examples of generating a POAP image using a composite watermark at a server (e.g., server 130 of FIG. 1) according to various example embodiments.

Referring to FIGS. 17A through 17E, in an example, in case that the category of the representative image is determined as “location,” the server 130 may generate a POAP image 1710a by synthesizing an emblem 1711a symbolizing the location and a character image 1713a on a background image 1715a (see FIG. 17A).

In an example, in case that the category of the representative image is determined as “exercise,” the server 130 may generate a POAP image 1710b by synthesizing text 1711b representing an exercise record and a character image 1713b on a background image 1715b (see FIG. 17B).

In an example, in case that the category of the representative image is determined as “food,” the server 130 may generate a POAP image 1710c by synthesizing a logo 1711c symbolizing a restaurant or store and a character image 1713c on a background image 1715c (see FIG. 17C).

In an example, in case that the category of the representative image is determined as “content,” the server 130 may generate a POAP image 1710d by synthesizing text 1711d representing a content title and a character image 1713d on a background image 1715d (see FIG. 17D).

In an example, in case that the category of the representative image is determined as “book,” the server 130 may generate a POAP image 1710e by synthesizing text 1711e representing a book name and a character image 1713e on a background image 1715e (see FIG. 17E).

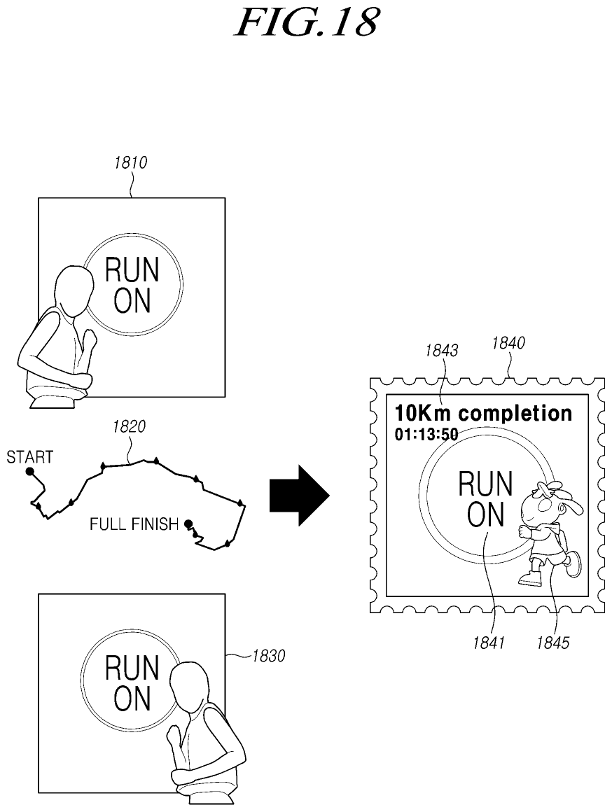

FIG. 18 is a diagram illustrating an example of generating a POAP image using a plurality of representative images at a server (e.g., server 130 of FIG. 1) according to various example embodiments.

Referring to FIG. 18, in case that the target event is a marathon requiring authentication of start and finish, the server 130 may obtain an image (e.g., first representative image 1810) for start authentication captured at a start time before starting and an image (e.g., second representative image 1830) for finish authentication captured at a finish point after finishing. The server 130 may additionally obtain a marathon course image 1820 as an image for completion authentication. The server 130 may authenticate that the attendee has completed the course by analyzing the first and second representative images 1810, 1830 and/or the course image 1820. Upon successful authentication, the server 130 may generate a POAP image 1840 authenticating marathon completion by synthesizing a character image 1845 owned as an NFT by the participant on a background image (e.g., marathon promotional image) 1841. The server 130 may generate the POAP image 1840 by synthesizing text about the marathon event participated in (e.g., 10 km) and/or the record as a watermark 1843 on the background image 1841. The server 130 may generate the POAP image 1840 by synthesizing both the watermark 1843 about the marathon event participated in (e.g., 10 km) and/or the record and a character image 1845 on the background image 1841.

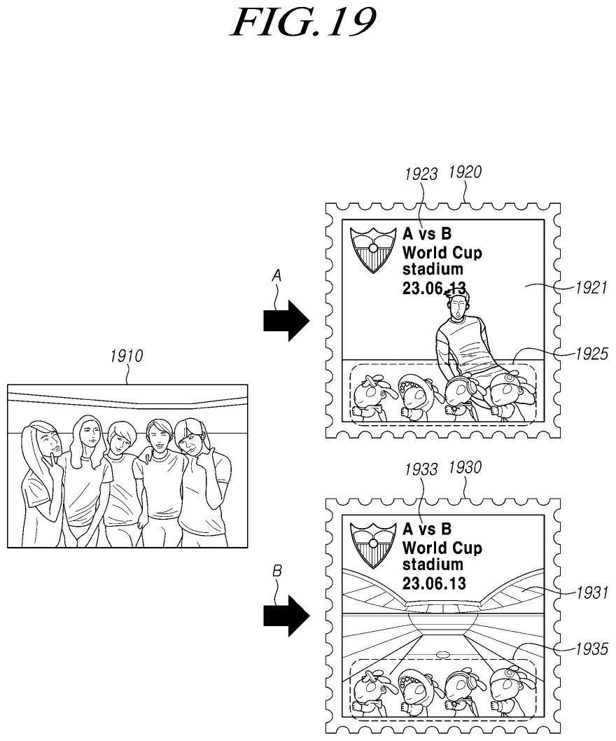

FIG. 19 is a diagram illustrating an example of generating a POAP image by reflecting a result of a target event at a server (e.g., server 130 of FIG. 1) according to various example embodiments.

Referring to FIG. 19, in case of attending an event for which a result may not be predicted, such as a soccer game, the server 130 may determine an image 1910 captured at a time when the game result may not be identified (e.g., at the time of entering the game) as the representative image. In case that an attendee is captured in the representative image, the server 130 may obtain a character image owned as an NFT by the captured attendee.

In case that the result of the corresponding event is identified, the server 130 may determine a background image capable of authenticating the result. In an example, in case that the cheered team wins (A), the server 130 may generate a background image 1921 from an image corresponding to a main scene of the game. In an example, in case that the cheered team does not win (B), the server 130 may generate a background image 1931 from an image corresponding to a panoramic view illustrating the soccer stadium where the game was held.

The server 130 may edit a pose and/or a facial expression of the character image by reflecting the result of the corresponding event, and generate a POAP image 1920 or 1930 by synthesizing the edited character image 1925, 1935 on the background image 1921, 1931.

The server 130 may generate a POAP image 1920 or 1930 by synthesizing text 1923 or 1933 about the result, location, and/or date and time of the corresponding event as a watermark on the background image 1921 or 1931.

The server 130 may generate a POAP image 1920 or 1930 by synthesizing both text 1923 or 1933 about the result, location, and/or date and time of the participated game and the edited character image 1925, 1935 as a watermark on the background image 1921 or 1931.

According to an embodiment, a program for executing a method for generating a POAP image at the user terminal 111 described above may be recorded on a computer readable storage medium.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. In connection to the description of the drawings, similar reference numerals may be used for similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., the memory 540) that is readable by a machine (e.g., the user terminal 111). For example, a processor (e.g., the processor 510) of the machine (e.g., the user terminal 111) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code that may be executed by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for generating a proof of attendance protocol (POAP) image at a server, the method comprising:
identifying user terminals of attending members who attended a target event from among enrolled members based on a non-fungible token (NFT) issued for a specified gathering;
collecting event-related data generated by the user terminals;
determining a background image corresponding to the target event based on the event-related data;
obtaining a character image designed to match the background image based on a character owned as an NFT by at least one selected attending member among the attending members and/or the collected event-related data; and
generating the proof of attendance protocol image certifying attendance at the event by synthesizing the character image as a watermark on the background image.

2. The method of claim 1, comprising:
determining a host for the target event from among the attending members;
transmitting at least one candidate image to be recommended as the background image to a host terminal being a user terminal of the host; and
receiving identification information indicating use as the background image from among the at least one candidate image from the host terminal.

3. The method of claim 1, wherein the event-related data includes at least one of a video captured by the user terminals, metadata of the captured video, ambient sound recorded at a time of video capture, schedule information, and/or a usage record of an application program.

4. The method of claim 1, comprising:
determining at least one attending member included in the background image as the at least one selected attending member; or
determining at least one attending member having a similarity greater than a threshold similarity to the background image from among the attending members as the at least one selected attending member by considering the event-related data.

5. The method of claim 1, comprising:
obtaining the watermark to be synthesized on the background image based on an emblem, a logo, and/or text corresponding to the specified gathering.

6. The method of claim 4, wherein the obtaining the character image includes:
obtaining the character image by considering attire, a pose, and/or a facial expression of the at least one selected attending member included in the background image; or
determining attire, a pose, and/or a facial expression of at least one character based on detailed context information identified from the event-related data and obtaining a character image of the determined attire, pose, and/or facial expression.

7. The method of claim 2, comprising:
transmitting the proof of attendance protocol image to the host terminal.

8. The method of claim 1, comprising:
transmitting the proof of attendance protocol image to the user terminals.

9. The method of claim 2, wherein the obtaining the character image includes:
analyzing the event-related data to extract core data related to the target event;
transmitting the core data to the host terminal;
receiving a category identifier corresponding to the core data from the host terminal;
obtaining detailed context information for the core data based on the category identifier;
determining attire, a pose, and/or a facial expression of at least one character based on the detailed context information; and
obtaining the character image by reflecting the determined attire, pose, and/or facial expression.

10. The method of claim 1, wherein the determining the background image includes:
determining a target image corresponding to the target event based on the event-related data; and
generating the background image by deleting an attending member image included in the target image.

11. A server comprising:
a transceiver;
at least one memory; and
at least one processor, comprising processing circuitry, operatively connected to the transceiver or the at least one memory, wherein the memory stores instructions that, when executed by at least one processor, individually or in any combination, cause the server to:
identify user terminals of attending members who attended a target event from among enrolled members based on a non-fungible token (NFT) issued for a specified gathering;
control the transceiver to collect event-related data generated by the user terminals;
determine a background image corresponding to the target event based on the event-related data;
obtain a character image designed to match the background image based on a character owned as an NFT by at least one selected attending member among the attending members and/or the collected event-related data; and
generate a proof of attendance protocol image certifying attendance at the event by synthesizing the character image as a watermark on the background image.

12. The server of claim 11, wherein the memory stores instructions that, when executed by at least one processor, individually or in any combination, cause the server to:
determine a host for the target event from among the attending members;
control the transceiver to transmit at least one candidate image to be recommended as the background image to a host terminal being a user terminal of the host; and
control the transceiver to receive identification information indicating use as the background image from among the at least one candidate image from the host terminal.

13. The server of claim 11, wherein the event-related data includes at least one of a video captured by the user terminals, metadata of the captured video, ambient sound recorded at a time of video capture, schedule information, and/or a usage record of an application program.

14. The server of claim 11, wherein the memory stores instructions that, when executed by at least one processor, individually or in any combination, cause the server to:
determine at least one attending member included in the background image as the at least one selected attending member; or
determine at least one attending member having a similarity greater than a threshold similarity to the background image from among the attending members as the at least one selected attending member by considering the event-related data.

15. The server of claim 11, wherein the memory stores instructions that, when executed by at least one processor, individually or in any combination, cause the server to:
obtain the watermark to be composited onto the background image based on an emblem, a logo, and/or text corresponding to the specified gathering.

16. The server of claim 14, wherein the memory stores instructions that, when executed by at least one processor, individually or in any combination, cause the server to:
obtain the character image by considering attire, a pose, and/or a facial expression of the at least one selected attending member included in the background image; or
determine attire, a pose, and/or a facial expression of at least one character based on detailed context information identified from the event-related data and obtain a character image of the determined attire, pose, and/or facial expression.

17. The server of claim 12, wherein the memory stores instructions that, when executed by at least one processor, individually or in any combination, cause the server to:
control the transceiver to transmit the proof of attendance protocol image to the host terminal.

18. The server of claim 11, wherein the memory stores instructions that, when executed by at least one processor, individually or in any combination, cause the server to:
control the transceiver to transmit the proof of attendance protocol image to the user terminals.

19. The server of claim 12, wherein the memory stores instructions that, when executed by at least one processor, individually or in any combination, cause the server to:
analyze the event-related data to extract core data related to the target event;
control the transceiver to transmit the core data to the host terminal;
control the transceiver to receive a category identifier corresponding to the core data from the host terminal;
obtain detailed context information for the core data based on the category identifier;
determine attire, a pose, and/or a facial expression of at least one character based on the detailed context information; and
obtain the character image by reflecting the determined attire, pose, and/or facial expression.

20. The server of claim 11, wherein the memory stores instructions that, when executed by at least one processor, individually or in any combination, cause the server to:
determine a target image corresponding to the target event based on the event-related data; and
generate the background image by deleting an attending member image included in the target image.
